(19) United States
(12) Patent Application Publication
(10) Pub. No.: US 2014/0081680 A1
(43) Pub. Date: Mar. 20, 2014

(54) METHODS AND SYSTEMS FOR EVALUATING TECHNOLOGY ASSETS USING DATA SETS TO GENERATE EVALUATION OUTPUTS

(71) Applicant: MasterCard International Incorporated, Purchase, NY (US)

(72) Inventors: Todd Telle, St. Louis, MO (US); Mark Clement Kwapiszeski, Dardenne Prairie, MO (US); Stephanie Michelle Dickinson, Collinsville, IL (US)

(73) Assignee: MasterCard International Incorporated, Purchase, NY (US)

(21) Appl. No.: 14/086,286

(22) Filed: Nov. 21, 2013

Related U.S. Application Data
(63) Continuation-in-part of application No. 13/570,090, filed on Aug. 8, 2012.

(51) Int. Cl. G06Q 10/06

(52) U.S. Cl. CPC G06Q 10/063
USPC 705/7.11

(57) ABSTRACT

A technology evaluation measurement (TEM) computer device for evaluating a technology asset of an entity includes a processor in communication with a memory. The TEM computer device is programmed to receive a first data set wherein the first data set includes data related to the a first technology asset, determine at least one evaluation function and at least one categorization function to apply to the first data set, process the first data set using the at least one evaluation function and the at least one categorization function to determine a second data set wherein the second data set includes data related to a technological evaluation of the first technology asset, and generate at least one evaluation output based upon the second data set, wherein the evaluation output represents an output indicating the technological evaluation of the first technology asset.

### CROSS REFERENCE TO RELATED APPLICATIONS

This application is a continuation-in-part application, which claims the benefit of U.S. patent application Ser. No. 13/570,090 filed Aug. 8, 2012, entitled, “METHODS AND SYSTEMS FOR EVALUATING TECHNOLOGY ASSETS,” which is hereby incorporated by reference in its entirety.

### BACKGROUND OF THE DISCLOSURE

The embodiments described herein relate generally to asset evaluation and, more particularly, to methods and systems for evaluating technology assets including receiving data related to a technology asset and generating a technology evaluation of the technology asset.

Evaluating investments in technological assets is an important part of improving the value and profitability of a company. The increase in popularity and competition in the software application industry over the last decade has created a necessity for companies to maximize the returns on the investments they make to develop such applications.

Known evaluation systems evaluate applications by questioning technology developers and/or engineers about achieved and projected business values of various applications. However, the questions asked typically allow for subjective answers from the developers and/or engineers. Accordingly, the evaluations are oftentimes subjective and may reflect the agendas of the developers and/or engineers. Thus, these known systems fail to provide an accurate evaluation of the software applications. Moreover, these known systems generally evaluate assets only on an individual level without providing a comparison to the other assets owned by the same company.

Accordingly, it is desirable to evaluate technology assets in an accurate and objective manner, and to provide an evaluation of technological assets in a standardized manner.

### BRIEF DESCRIPTION OF THE DISCLOSURE

In one embodiment, a technology evaluation measurement (TEM) computer device for evaluating a technology asset of an entity is provided. The TEM computer device includes a processor in communication with a memory. The TEM computer device is programmed to receive a first data set including data related to the a first technology asset, determine at least one evaluation function and at least one categorization function to apply to the first data set wherein the at least one categorization function is configured to determine a context of the first technology asset and wherein the at least one evaluation function is configured to determine a quantitative evaluation of the first technology asset based on the first data set and the context of the first technology asset, process the first data set using the at least one evaluation function and the at least one categorization function to generate a second data set wherein the second data set includes data related to a technological evaluation of the first technology asset, and generate at least one evaluation output based upon the second data set, wherein the evaluation output represents an output indicating the technological evaluation of the first technology asset.

In another embodiment, a computer-implemented method for evaluating a technology asset of an entity using a technology evaluation measurement (TEM) computer device is provided. The TEM computer device includes a processor in communication with a memory. The method includes receiving a first data set by the TEM computer device wherein the first data set includes data related to the a first technology asset, determining at least one evaluation function and at least one categorization function to apply to the first data set wherein the at least one categorization function is configured to determine a context of the first technology asset and wherein the at least one evaluation function is configured to determine a quantitative evaluation of the first technology asset based on the first data set and the context of the first technology asset, processing the first data set using the at least one evaluation function and the at least one categorization function to generate a second data set wherein the second data set includes data related to a technological evaluation of the first technology asset, and generating at least one evaluation output based upon the second data set wherein the evaluation output represents an output indicating the technological evaluation of the first technology asset.

In yet another embodiment, one or more non-transitory computer-readable storage media for evaluating a technology asset of an entity by a technology evaluation measurement (TEM) computer device is provided. The TEM computer device includes a memory and a processor. The computer-readable storage media have computer-executable instructions embodied thereon. When executed by the processor, the computer-executable instructions cause the processor to receive a first data set wherein the first data set includes data related to the a first technology asset, determine at least one evaluation function and at least one categorization function to apply to the first data set wherein the at least one categorization function is configured to determine a context of the first technology asset and wherein the at least one evaluation function is configured to determine a quantitative evaluation of the first technology asset based on the first data set and the context of the first technology asset, process the first data set using the at least one evaluation function and the at least one categorization function to generate a second data set wherein the second data set includes data related to a technological evaluation of the first technology asset, and generate at least one evaluation output based upon the second data set, wherein the evaluation output represents an output indicating the technological evaluation of the first technology asset.

### BRIEF DESCRIPTION OF THE DRAWINGS

FIGS. 1-25 show example embodiments of the method and system described herein.

FIG. 1 is a simplified block diagram of an example embodiment of an asset evaluation computer system including a technology evaluation measurement (TEM) computer device in accordance with one embodiment of the present invention.

FIG. 2 is an expanded block diagram of an example embodiment of a server architecture of an asset evaluation computer system, including the TEM computer device shown in FIG. 1 in accordance with one embodiment of the present invention.

FIG. 3 is a block diagram of an example embodiment of a user computer device as shown in FIGS. 1 and 2.

FIG. 4 is a block diagram of an example embodiment of a server computer device as shown in FIGS. 1 and 2.

FIG. 5 is a data flow diagram showing the TEM computer device receiving and processing a first data set and producing evaluation output.

FIG. 6 is a data flow diagram showing an expanded view of the generation of TME data shown in FIG. 5.

FIG. 7 is a detailed data flow diagram illustrating the generation, distribution, and collection of survey questions shown in FIG. 6 and the processing of the collected information into evaluation output shown in FIG. 5.

FIG. 8 is an example process flow diagram illustrating a method of generating survey questions shown in FIG. 6 for display to a subject matter expert (SME) by TME computer device shown in FIG. 5.

FIG. 9 is an example data flow diagram showing a method of scoring data including TME data and the first data set shown in FIG. 5 using a dynamic scoring system shown in FIG. 5 to generate business and technical scores shown in FIG. 5.

FIG. 10 is an example process flow diagram illustrating a method of applying weights to applications which may be used by the dynamic scoring system and evaluation function of FIG. 5.

FIG. 11 is an example process flow diagram illustrating the method for calculating the business score and the technical score shown in FIG. 5.

FIG. 12A is a data flow diagram showing a process implemented by the TEM computer device shown in FIGS. 1 and 2 for evaluating technology assets in accordance with one embodiment of the present invention.

FIG. 12B is a data flow diagram showing a process implemented by a TME computer device shown in FIGS. 1 and 2 for evaluating technology assets in accordance with one embodiment of the present invention.

FIG. 13A is a screenshot of a first evaluation output produced by the TEM computer shown in FIGS. 1 and 2.

FIG. 13B is a screenshot of a second evaluation output produced by the TEM computer shown in FIGS. 1 and 2.

FIG. 14 is a screenshot of a reporting screen from the TME computer device shown in FIGS. 1 and 2 in accordance with an example embodiment of the present invention.

FIG. 15 is a chart that illustrates exemplary questions and answers posed to subject matter experts by the TME computer device shown in FIGS. 1, and 2 in accordance with an example embodiment of the present invention.

FIG. 16 shows an example summary report at an asset level as outputted by the TME computer device shown in FIGS. 1 and 2 in accordance with an example embodiment of the present invention.

FIG. 17 is an example graph generated by the TME computer device shown in FIGS. 1 and 2 illustrating the maturity of a plurality of assets relative to one another.

FIG. 18 is a screenshot generated by at least one of the TEM computer device and the TME computer device shown in FIGS. 1 and 2 and allowing a user to access technological maturity data

FIG. 19 is a screenshot generated by at least one of the TEM computer device and the TME computer device shown in FIGS. 1 and 2 and illustrating the technical maturity scores for a plurality of assets.

FIG. 20 is a screenshot generated by at least one of the TEM computer device and the TME computer device shown in FIGS. 1 and 2 and illustrating growth scores for a plurality of assets.

FIG. 21 is a screenshot generated by at least one of the TEM computer device and the TME computer device shown in FIGS. 1 and 2 and illustrating a tabular view of technical and business maturity scores for a plurality of assets.

FIG. 22 is a screenshot generated by at least one of the TEM computer device and the TME computer device shown in FIGS. 1 and 2 and illustrating a report of technical maturity scores for a particular asset over a period of time.

FIG. 23 is a screenshot generated by at least one of the TEM computer device and the TME computer device shown in FIGS. 1 and 2 and illustrating a report of the breakdown of technical maturity scores for a particular asset.

FIG. 24 is a screenshot generated by at least one of the TEM computer device and the TME computer device shown in FIGS. 1 and 2 and illustrating a further breakdown of technical maturity scores for a particular asset.

FIG. 25 is a diagram of components of one or more example computer devices that may be used in the environment shown in FIG. 5.

### DETAILED DESCRIPTION OF THE DISCLOSURE

Embodiments of the present invention described herein relate to methods and systems for determining a technological evaluation measurement of assets of an organization. The assets are evaluated using a computer system, such as a technology evaluation measurement (TEM) computer device. In the example embodiment, the assets compared by the TEM computer device are technology assets associated with a company or a portfolio. In other embodiments, the TEM computer device may compare any assets capable of having a technological evaluation. Technological evaluation as used herein represents at least one of an evaluation of resources invested in the deployment of assets, an evaluation of the available capacity of assets to carry out additional business functions, and an evaluation of recommended resource utilization for assets.

For example, during operation, a user, or analyst, selects a plurality of assets for the TEM computer device to evaluate. For the specified assets to be evaluated, the TEM computer device is configured to receive a first data set wherein the first data set includes data related to the a first technology asset. The first data set may include any information related to the first technology asset including, without limitation, historic resource investments, planned resource investments, current resource utilization, historic financial investment, planned financial investment, alternative asset options, and organizational and logistical plans related to the first technology asset. The first data set may additionally include data from a plurality of sources. The first data may be evaluated depending upon the relative significance of each data point in the context of the category of the technology asset. Accordingly, the TEM computer device determines at least one evaluation function and at least one categorization function to apply to the first data set and processes the first data set into a second data set using the evaluation functions and categorization functions. Using the second data set, the TEM computer device generates at least one evaluation output based upon the second data set. The evaluation output represents an evaluation of the technology asset in terms of, for example, a resource utilization analysis, an investment analysis, or a system capacity analysis.

The methods and systems described herein may be implemented using computer programming or engineering techniques including computer software, firmware, hardware or any combination or subset thereof, wherein the technical effect may include at least one of: (a) receiving, by a technology evaluation measurement (TEM) computer device, a first data set, wherein the first data set includes data related to the a first technology asset; (b) determining, by the TEM computer device, at least one evaluation function and at least one categorization function to apply to the first data set; (c) processing the first data set using the at least one evaluation function and the at least one categorization function to determine a second data set, wherein the second data set includes data related to a technological evaluation of the first technology asset; (d) generating at least one evaluation output based upon the second data set, wherein the evaluation output represents an output indicating the technological evaluation of the first technology asset; (e) receiving, by the TEM computer device, a first data feed from at least one external data source and extracting the first data set from the first data feed; (f) receiving response data from each of a plurality of subject matter experts regarding the technological evaluation of the first technology asset and processing the response data with the first data set; (g) automatically polling the plurality of subject matter experts for response data; (h) generating an investment monitoring output representative of investment allocated to the first technology asset; (i) generating a capacity monitoring output representative of resource capacity available related to the first technology asset; (j) processing the first data set using the at least one evaluation function wherein the at least one evaluation function is a dynamic weighting function; (k) processing the first data set using at least one categorization function wherein the at least one categorization function determines an investment category related to the first technology asset; and (l) calculating a business value score and a technical maturity score for the first technology asset based upon at least in part upon the second data set, wherein the business value score represents an overall value and impact the first technology asset has in a marketplace, and wherein the technical maturity score represents an amount of resources invested to develop and implement the first technology asset.

The assets evaluated herein may additionally be evaluated using a computer system such as a technology maturity evaluation (TME) computer device. The TME computer device is programmed to receive an asset identifier identifying an asset selected for evaluation and to electronically display business value questions and technical maturity questions for the selected asset, wherein each question is designated for a response by a subject matter expert. The TME computer device is further programmed to receive response data from each of the subject matter experts and calculate a business value score and a technical maturity score for the selected asset based on the response data. Data produced by the TME computer device may be utilized and incorporated into the first data set received by the TEM computer device. In some examples, the TME computer device and the TEM computer device may represent the same physical computer device. In other examples, the TME computer device and the TEM computer device may be in communication with one another.

The following detailed description illustrates embodiments of the invention by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, systems and methods of objectively evaluating technology assets, and generating an evaluation output indicating the technological evaluation of the first technology asset. However, it is contemplated that this disclosure has general asset to computing systems in industrial, commercial, and residential assets.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

As used herein, the terms “computer”, “computer device”, and “computing device” may be used interchangeably. Furthermore, references to a single computer or a computer device are not intended to be interpreted as excluding the existence of additional embodiments which incorporate a plurality of computers or computer devices.

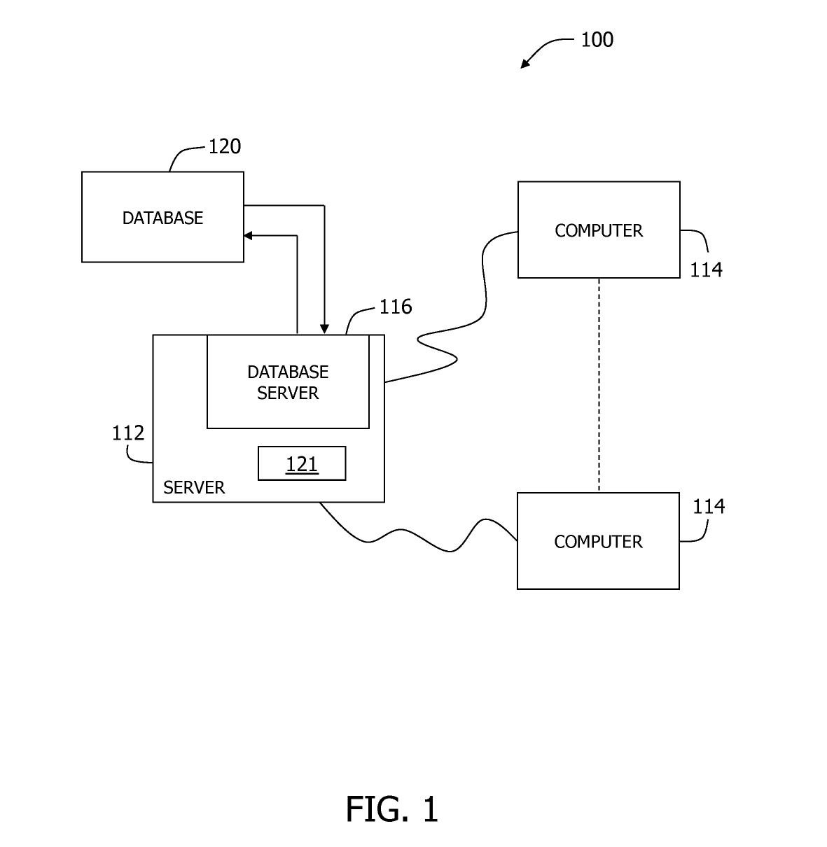

FIG. 1 is a simplified block diagram of an example embodiment of an asset evaluation computer system 100 including a technology evaluation measurement (TEM) computer device in accordance with one embodiment of the present invention. In the example embodiment, computer system 100 is configured to evaluate assets associated with an organization.

More specifically, in the example embodiment, computer system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment. Server system 112 may be associated with any company having assets capable of being evaluated.

A database server 116 is connected to database 120, which contains information on a variety of matters, as described below in greater detail. In one embodiment, database 120 is a non-centralized database stored remotely from server system 112, and can be accessed by potential users at one of client systems 114 by logging onto server system 112 through one of client systems 114. In an alternate embodiment, database 120 may be a centralized database stored on server system 112. Database 120 may store data generated as part of asset evaluation activities conducted over the network, including data relating to previously evaluated assets, financial data, operational data, and logistical data.

System 100 also includes a TEM computer device 121, which may be connected to one or more client systems 114, and may be connected to server system 112. TEM computer device 121 is interconnected to the Internet through many interfaces including a network, such as a LAN or a WAN, dial-in-connections, cable modems, wireless modems, and/or special high-speed ISDN lines. In one embodiment, TEM computer device 121 is located on server system 112 and can be accessed by potential users at one of client systems 114 by logging onto server system 112 through one of client systems 114. In an alternate embodiment, TEM computer device 121 may be non-centralized and is located remotely from server system 112. TEM computer device 121 is capable of determining a technological evaluation based upon a first data set including data related to a first technology asset of a company's assets.

In the example embodiment, each client system 114 is associated with a user and may be referred to as a user computer device 114. User computer device 114 may access and utilize TEM computer device 121 on server system 112. In one embodiment, user computer device 114 is a computer including a web browser, such that server system 112 is accessible to user computer device 114 using the Internet. User computer device 114 is interconnected to the Internet through many interfaces including a network, such as a local area network (LAN) or a wide area network (WAN), dial-in-connections, cable modems, and special high-speed ISDN lines. User computer device 114 may also include a remote computer device, such as a web-based phone, smartphone, mobile phone, personal digital assistant (PDA), iPhone® (iPhone is a registered trademark of Apple, Incorporated located in Cupertino, Calif.), Android® (Android is a registered trademark of Google Incorporated, located in Mountain View, Calif.), and/or any device capable of executing stored computer-readable instructions. User computer device 114 can be associated with a subject matter expert or with another user utilizing system 100. User computer device 114 is configured to access service applications offered by the company and communicate with other user computer devices 114 within system 100.

As described herein, computer device 114 may also include a technology maturity evaluation (TME) computer device 114 programmed to receive an asset identifier identifying an asset selected for evaluation and to electronically display business value questions and technical maturity questions for the selected asset, wherein each question is designated for a response by a subject matter expert. TME computer device 114 is further programmed to receive response data from each of the subject matter experts and calculate a business value score and a technical maturity score for the selected asset based on the response data. Data produced by the TME computer device 114 may be utilized and incorporated into the first data set received by the TEM computer device 121.

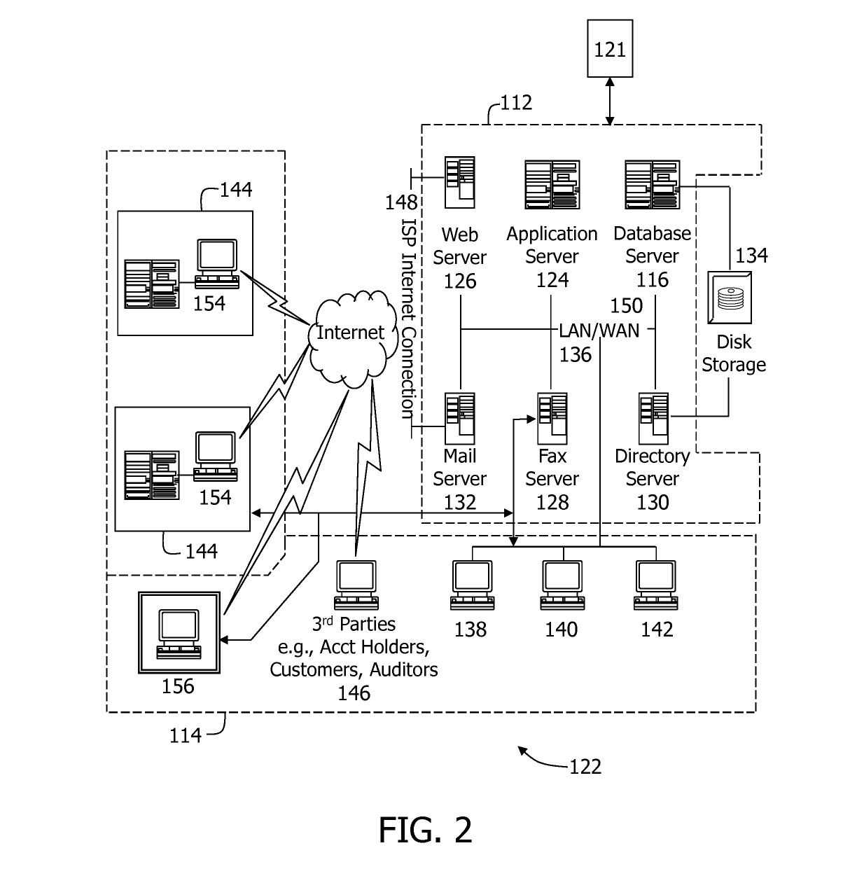

FIG. 2 is an expanded block diagram of an example embodiment of a server architecture of an asset evaluation computer system 122 including TEM computer device 121 (shown in FIG. 1) in accordance with one embodiment of the present invention. Components in system 122, identical to components of system 100 (shown in FIG. 1), are identified in FIG. 2 using the same reference numerals as used in FIG. 1. System 122 includes server system 112, client systems 114, and TEM computer device 121 (shown in FIG. 1). Server system 112 further includes database server 116 (shown in FIG. 1), a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

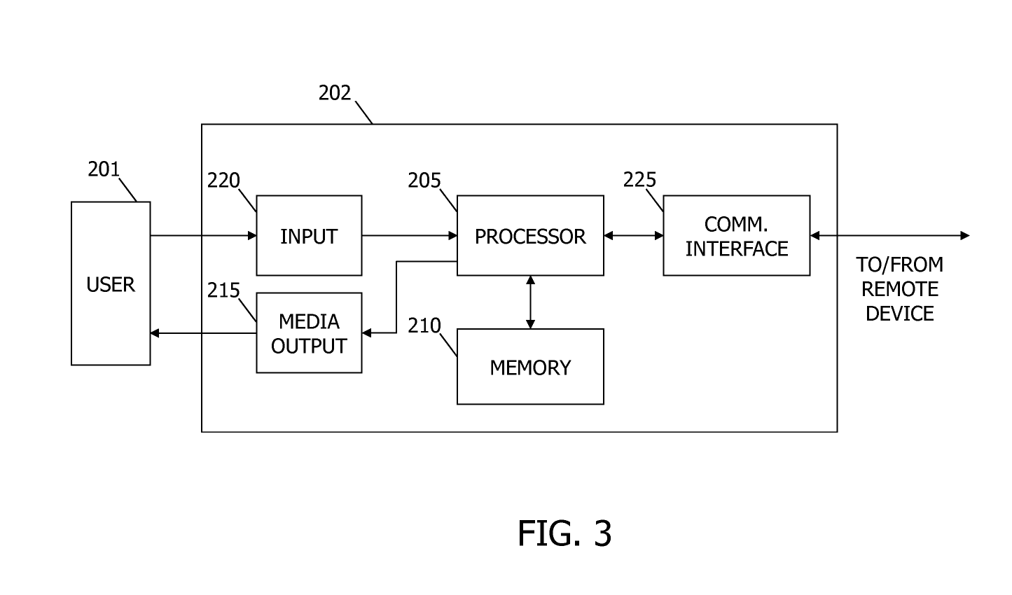

FIG. 3 illustrates an example configuration of a user computer device 202 operated by a user 201. User computer device 202 may include, but is not limited to, client systems 114, 138, 140, and 142, 146, workstation 154, and manager workstation 156 (all shown in FIG. 2).

User computer device 202 includes a processor 205 for executing instructions. In some embodiments, executable instructions are stored in a memory area 210. Processor 205 may include one or more processing units (e.g., in a multi-core configuration). Memory area 210 is any device allowing information such as executable instructions and/or other data to be stored and retrieved. Memory area 210 may include one or more computer readable media.

User computer device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

User computer device 202 also includes an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

User computer device 202 may also include a communication interface 225, which is communicatively couplable to a remote device such as server system 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112 (shown in FIGS. 1 and 2), including TEM computer device 121 (shown in FIGS. 1 and 2). A client application allows user 201 to interact with a server application from server system 112.

Memory area 210 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

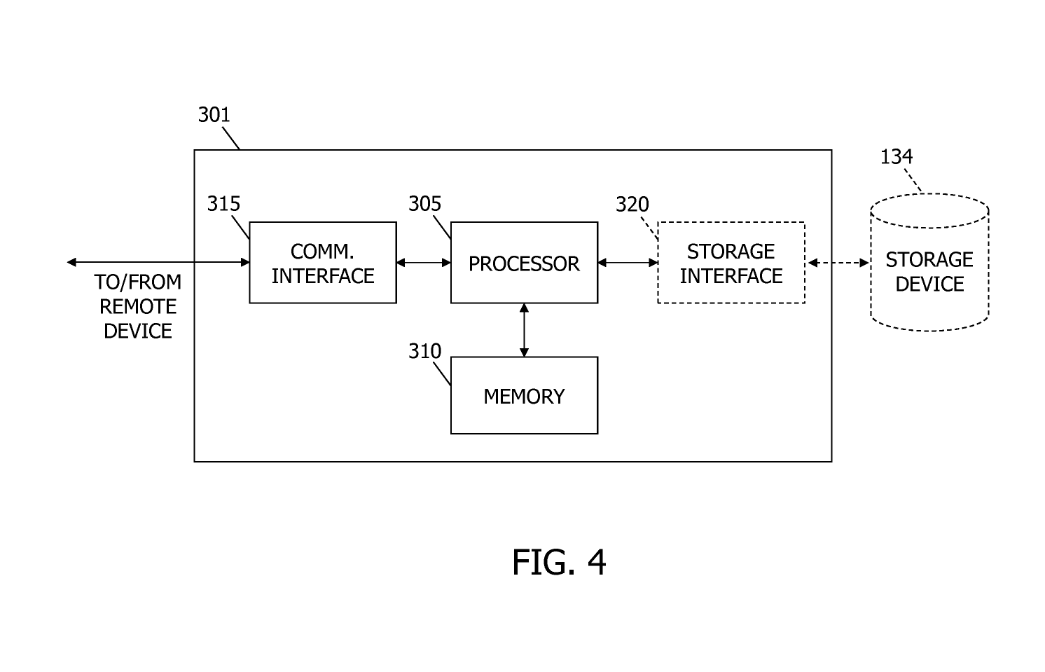

FIG. 4 illustrates an example configuration of a server system 301, such as server system 112 (shown in FIGS. 1 and 2). Server system 301 may include, but is not limited to, database server 116 (shown in FIGS. 1 and 2), TEM computer device 121 (shown in FIGS. 1 and 2), application server 124, web server 126, fax server 128, directory server 130, and mail server 132 (all shown in FIG. 2).

Server system 301 includes a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as user computer device 114 (shown in FIGS. 1 and 2), user computer device 202 (shown in FIG. 3), or another sever system 301. For example, communication interface 315 may receive requests from user computer device 114 via the Internet, as illustrated in FIGS. 1 and 2.

Processor 305 may also be operatively coupled to a storage device 134 (shown in FIG. 2). Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to Server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

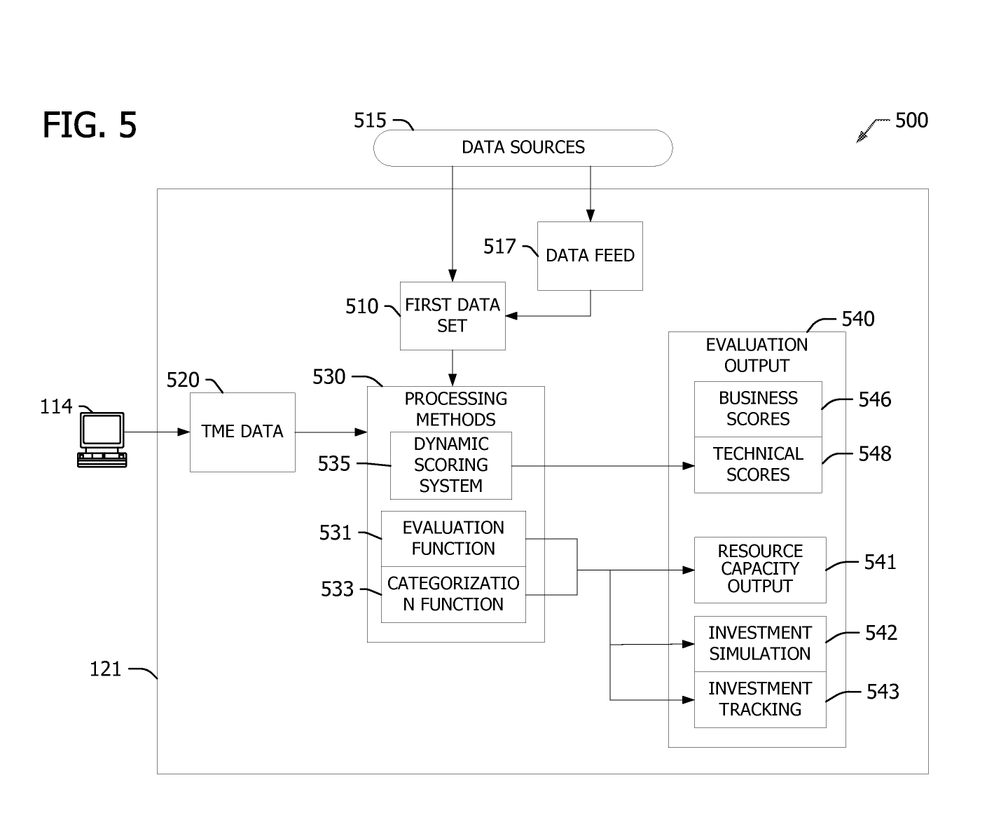

FIG. 5 is a data flow diagram 500 showing the TEM computer device 121 receiving and processing a first data set 510 and producing evaluation output 540. TEM computer device 121 is in communication with data sources 515. Data sources 515 may include any sources which are in networked communication with TEM computer device 121. Data sources 515 may provide data including a first data set 510 and a data feed 517 to TEM computer device 121. First data set 510 and data feed 517 represent data which relates to a first technology asset including, for example, financial systems data, operational metrics data, survey data, resource availability data, and market data.

First data set 510 may be received by TEM computer device 121 from a plurality of data sources 515 or a single data source 515. First data set 510 is received in a data format suitable for processing by TEM computer device 121. In the example embodiment, TEM computer device 121 receives first data set 510 as a comma separated value (CSV) file. Alternately, TEM computer device 121 may receive first data set 510 in any suitable format including, without limitation, tab-delimited files, database records, flat files, and extensible markup language (XML) files.

In at least some examples, data sources 515 provide data through the use of an application program interface (API) exposing a connection between data sources 515 and TEM computer device 121. In such examples, the API call may be made by TEM computer device 121 in a data “pull” model wherein TEM computer device 121 is polling data sources 515 for information. Alternately the API call may be made data sources 515 in a data “push” model where data sources 515 provide information on demand. In additional examples, first data set 510 and data feed 517 may be received by TEM computer device 121 in a manual process facilitated by a user such as user 201 (shown in FIG. 3). For example, user 201 may manually provide a file such as a flat file or an XML file to TEM computer device 121.

In one example, data sources 515 may provide a data feed 517. For example data sources 515 may include without limitation, web services, Really Simple Syndication (RSS) feeds, resource description framework (RDF) feeds, atomic feeds, and any other feed which may provide data in an automatic, substantially streaming, format. Data feed 517 is processed by TEM computer device 121 into first data set 510. Processing data feed 517 into first data set 510 includes any suitable method for processing data feed 517 including, without limitation, structured language parsing, natural language processing, and manual extraction using a user such as user 201 (shown in FIG. 3).

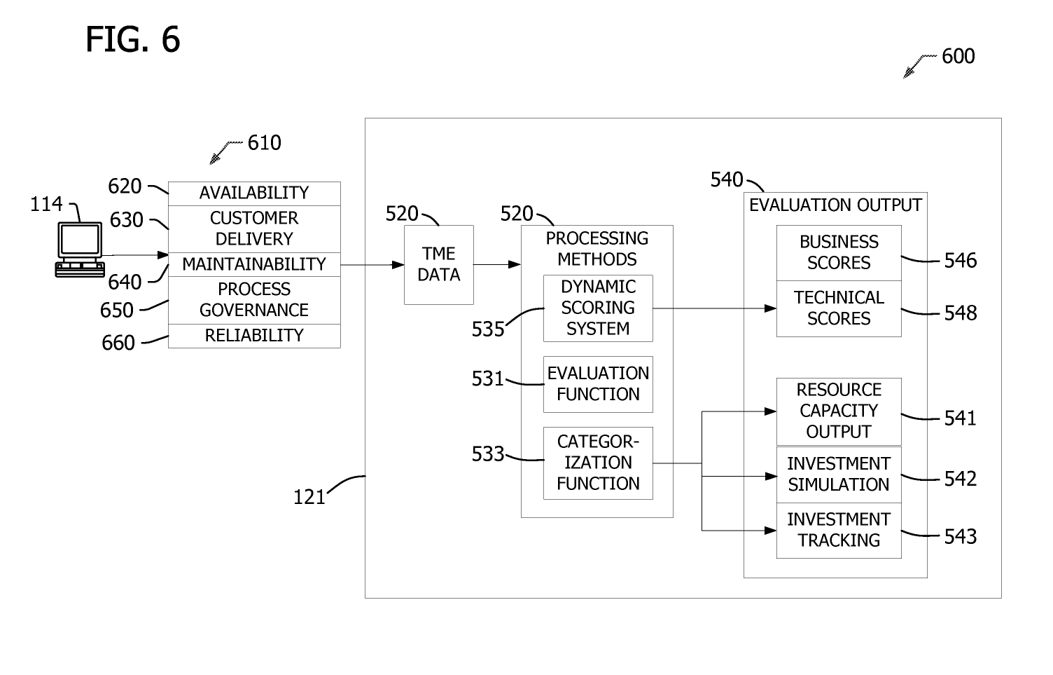

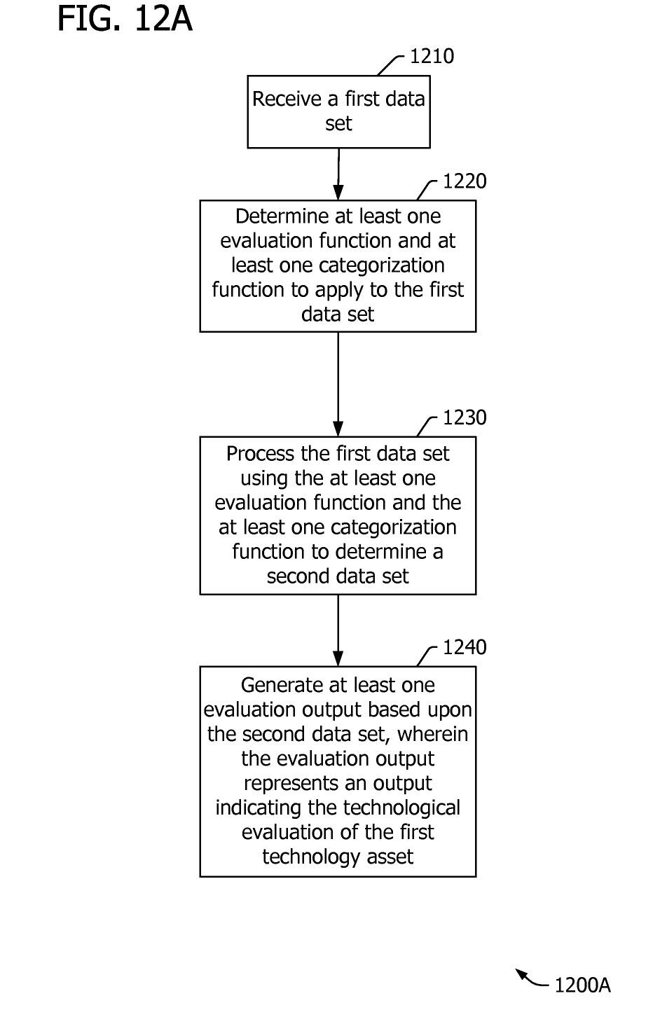

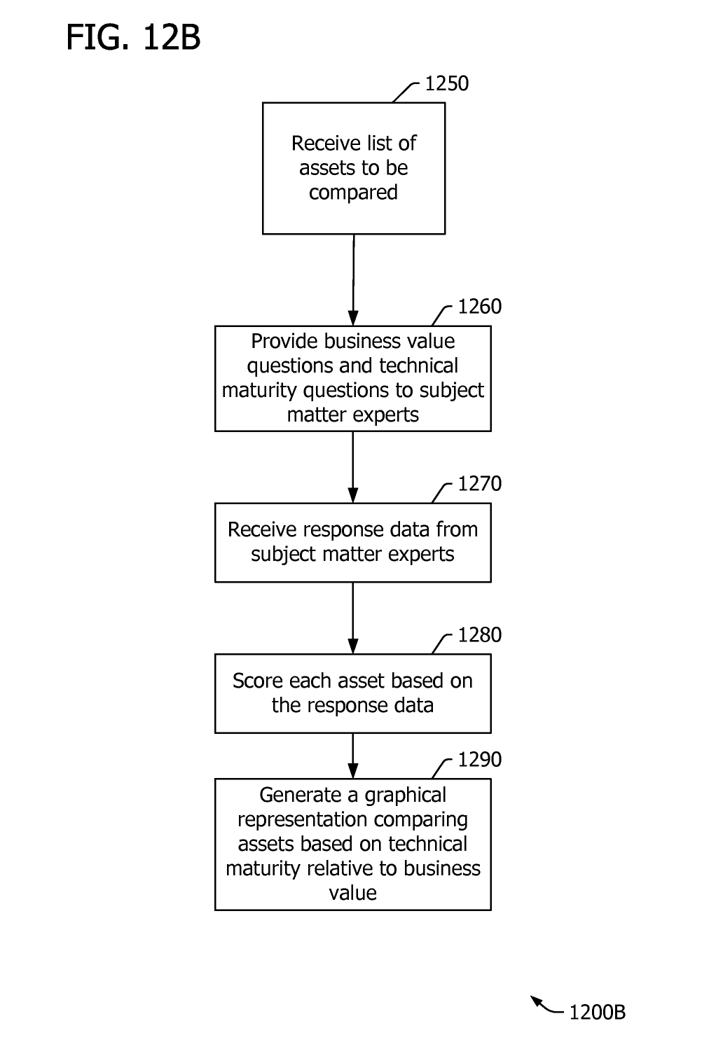

TEM computer device 121 is capable of additionally receiving technology maturity evaluation (TME) data 520 received from a TME computer device 114 and using TME data 520. As described in FIGS. 6 and 12B, TME computer device 114 evaluate any assets capable of being evaluated by business value and/or technical maturity. TME computer device 114 presents a plurality of questions relating to the business value and the technical maturity of the asset to a group of subject matter experts and receives response data from the subject matter experts. TME computer device 114 additionally is capable of scoring a first technology asset based upon the response data and generating a graphical representation comparing a plurality of technology assets. As described herein, TME data 520 may include response data from subject matter experts, scoring data generated by TME computer device 114 using response data, and graphical representations generated by TME computer device 114.

In at least some examples, TEM computer device 121 is additionally configured to automatically poll subject matter experts and receive TME data 520 without utilizing TME computer device 114. In such examples, TEM computer device 121 generates and presents a plurality of questions relating to the business value and the technical maturity of the asset to a group of subject matter experts and receives response data from the subject matter experts and receives response data. In such examples, TEM computer device 121 is further configured to score a first technology asset based upon the response data and to generate a graphical representation comparing a plurality of technology assets.

TEM computer device 121 additionally includes a plurality of processing methods 530. Processing methods 530 may be stored at memory 210 (shown in FIG. 3), generated dynamically, or received from external systems. In some examples, processing methods 530 may be received in conjunction with first data set 510 or TME data 520. Processing methods 530 represent algorithms used to normalize and evaluate data including first data set 510 and TME data 520. More specifically, processing methods 530 includes at least evaluation function 531, categorization function 533, and dynamic scoring system 535.

Evaluation function 531 is used by TEM computer device 121 to determine how to weigh characteristics of data included in first data set 510 and TME data 520. Accordingly, at least some evaluation functions 531 may be referred to as “weighing functions”. For example, first data set 510 may include information from a range of time periods. In some examples, older data may be considered less relevant and factor less significantly in an evaluation. In a second example, first data set 510 may include data from a plurality of data sources 515 wherein at least some data sources 515 are considered to be less reliable than other data sources 515. In some examples, reliability of data sources 515 may cause evaluation function 531 to “discount” the value of less reliable data sources 515. Such feedback on reliability may be provided by any source including, without limitation, human users, expert systems, and databases. Accordingly, such feedback functionally allows evaluation function 531 to serve as a dynamic weighting function wherein the weighting is substantially determined by a source including, without limitation, a user such as user 201 and an expert system. In a third example, data sources 515 may include financial or operational projections wherein one projection is preferred over others. In some examples, evaluation function 531 may cause preferred projections to factor more significantly into an evaluation of first data set 510 than less preferred projections. More generally, evaluation function 531 represents processing first data set 510 and/or TME data 520 into a quantitative evaluation. In one example, evaluation function 531 determines the percentage of questions answered in TME data 520 by a subject matter expert (SME) indicating that the technology asset is of a particular maturity. In another example, evaluation function 531 analyzes first data set 510 to determine the percentage of components of first data set 510 which indicate that the technology asset is of a particular maturity.

Categorization function 533 is used by TEM computer device 121 to determine the context of first technology asset. For example, one first technology asset may relate to hardware storage for critical customer data while a second first technology asset relates to networking infrastructure for a remote non-mission critical facility. Categorization function 533 may distinguish the contexts accordingly. Further, categorization function 533 may impact evaluation function 531. For example, in less critical contexts such as networking infrastructure in the remote, non-mission critical facility, evaluation function 531 may be different than it would be in the context of hardware storage for critical customer data. In this example, the hardware context may indicate a lower tolerance for resource capacity limitations than the networking infrastructure context. In other words, evaluation function 531 may determine a quantitative evaluation representing an evaluation of the technology based on the context determined by categorization function 533 and at least one of first data set 510 and TME data 520.

Dynamic scoring system 535 is used to process first data set 510 and TME data 520 to produce business investment scores 546 and technical investment scores 548, discussed in FIG. 12B. First data set 510 and TME data 520 may be weighted by importance, so that when comparing multiple assets, certain characteristics may be highlighted, or given more weight, to reflect importance or significance thereof

TEM computer device 121 is configured to generate evaluation output 540. Evaluation output 540 includes data which may be produced by TEM computer device 121 relevant to the technological evaluation of a first technological asset. Evaluation output includes resource capacity output 541, investment simulation 542, investment tracking 543, business scores 546, and technical scores 548.

Resource capacity output 541 represents a projection of resources available for a first technology asset. In a first example, resource capacity output 541 is a projection indicating a scored capacity rating for a plurality of technology assets along with their respective business values. This example facilitates assessing, for example, when mission critical technology assets are under-provisioned and when low value technology assets are over-provisioned. Such a projection can accordingly assist in technology evaluation decisions. In a second example, resource capacity output 541 represents a display indicating the state of resource capacity for a particular technology asset. More specifically, resource capacity output 541 indicates whether a particular technology asset is over-provisioned, properly provisioned, or under-provisioned based upon a projection of business activity related to the technology asset. Alternately, resource capacity output 541 may include a capacity indicator status wherein the capacity of the technology asset is indicated to be one of under capacity, at capacity, or over capacity. The visualization associated with the example further indicates whether the technology asset should be “watched” or “refueled”.

Investment simulation 542 represents a projection of financial impact associated with varying investment strategies for a particular technology asset. Investment simulation 542 allows various models of business activity to be considered along with simulations of changes in investment in a technology asset. Investment simulation 542 also includes simulations of revenue and profitability related to investment in the technology asset. Investment tracking 543 represents a display of historic, present, and projected investment in a particular technology asset. Investment tracking 543 may track investment in terms of any investment including, without limitation, financial capital, opportunity costs, and human resource capital.

Evaluation output 540 may be generated by TEM computer device 121 as web content served to users 201, data files, or application content. Evaluation output 540 may be generated dynamically by programs configured to render HTML files, PDF files, or other file formats. Evaluation output 540 may further be generated by using APIs for visualization tools. Such APIs may be proprietary or open-source. In one example, evaluation output 540 is made available to users 201 using at least one of a web server and a file server associated with TEM computer device 121.

FIG. 6 is a data flow diagram 600 showing an expanded view of the generation of TME data 520. As discussed in FIG. 4, TME data 520 may be received by TEM computer device 121, processed by processing methods 530, and used alone or in conjunction with first data set 510 (shown in FIG. 5) to generate evaluation output 540. In diagram 600, additional details on the generation of TME data 520 are shown.

TME computer device 114 generates a plurality of survey questions 610 which can be received by a subject matter expert (SME) at a SME computing device (not shown in FIG. 6). The SME provides input which is received by TME computer device 114 (not shown in FIG. 6). Survey questions 610 can include any group of questions which may be used to evaluate the technological maturity of an asset. Accordingly, survey questions 610 may include, for example and without limitation, availability questions 620, customer delivery questions 630, maintainability questions 640, process governance questions 650, and reliability questions 660.

Availability questions 620 include questions regarding the availability of assets including, for example and without limitation, questions regarding disaster recovery resources available to the asset, the support resources available to the asset, the outage response resources available to the asset, and the performance management resources available to the asset.

Customer delivery questions 630 include questions directed to the quality, depth, and scalability of customer support and enablement. Customer delivery questions 630 include questions regarding the customer delivery of assets including, for example and without limitation, questions regarding the set-up procedures and mechanisms related to the asset, the customer support resources associated with the asset, the documentation available for the asset, the customer impact associated with the asset, and the customer training tools available for the asset.

Maintainability questions 640 include questions directed to the maintainability of the asset including, for example and without limitation, questions regarding the complexity of the asset, the configurability of the asset, the underlying codebase associated with the asset, and the human resources available to support the asset.

Process governance questions 650 include questions directed to the release cycle and management of the asset including, for example and without limitation, questions regarding release management methods and approaches associated with the asset, documentation associated with the asset, service definitions associated with the asset, metrics associated with the asset, change management associated with the asset, problem management associated with the asset, and incident management associated with the asset.

Reliability questions 660 include questions directed to the reliability of the asset including, for example and without limitation, questions regarding the scalability of the asset, the versioning approaches and history of the asset, the asset management, the processes associated with the management and release of the asset, the testing and QA associated with the asset, and the security model associated with the asset.

Survey questions 610 are provided to SMEs in a method described below and collected as TME data 520 which may be received by TEM computer device 121. Accordingly, TME data 520 may be processed by TEM computer device 121 in the manner described in FIG. 5.

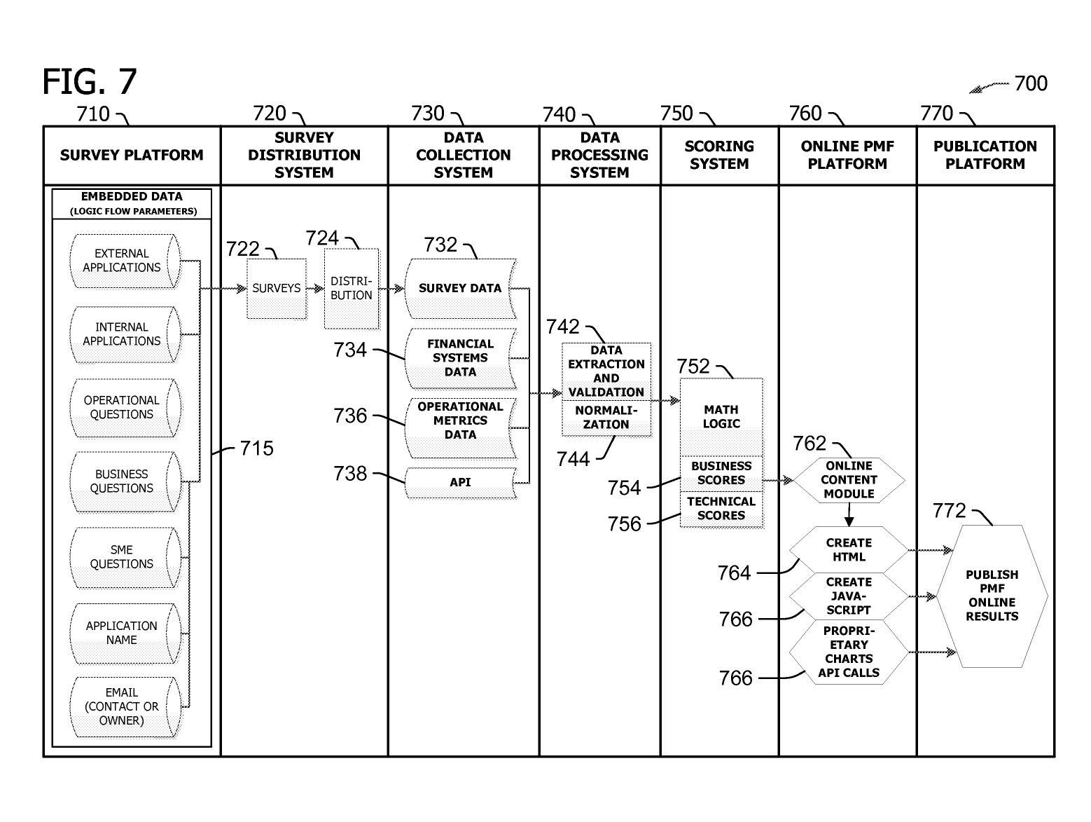

FIG. 7 is a detailed data flow diagram 700 illustrating the generation, distribution, and collection of survey questions 610 (shown in FIG. 6) and the processing of the collected information into evaluation output 540 (shown in FIG. 5). Survey questions 610 are generated by a survey platform 710 using embedded data 715. Survey platform 710 is designed to generate survey questions 610 to be viewed by a SME. Embedded data 715 includes data used to generate survey questions 610 including, without limitation, business question data, operational question data, and SME question data. Embedded data 715 may be associated with one asset, a plurality of assets, or categories of assets. Additionally, embedded data 715 may include, without limitation, information used to contact an SME and provide questions including contact information for the SME and a name of a survey question application. Embedded data 715 also includes external and internal application data which may be used to generate survey questions 610. As described below, survey platform 710 may include references to embedded data in a unique URL associated with each survey 722.

Survey questions 610 are distributed by survey distribution system 720 which initially generates a plurality of surveys 722 associated with unique URLs and distributes 724 the plurality of surveys. Survey distribution system 720 may distribute 724 surveys 722 using any appropriate mechanism including, for example and without limitation, web publication, email, SMS, and chatting tools for computer devices and mobile computer devices.

Response data received from users such as user 201 (shown in FIG. 3) is entered in surveys 722 and received as survey data 732. Survey data 732 is collected by data collection system 730 along with financial systems data 734, operational metrics data 736, and API data 738. Financial systems data 734 may include any financial data related to the asset and its function in the business. Operational metrics data 736 may similarly include any operations data related to the asset and its function in the business. API data 738 may include any data which is obtained by making an API call to an external data feed which may be provided by an API. API data 738 may include any data relevant to the evaluation of the technological maturity of an asset.

Data collected by data collection system 730 is processed by data processing system 740. Data processing system includes a data extraction and validation component 742 and a normalization component 744. Data extraction and validation component 742 extracts and validates information collected by data collection system 730. Data extraction and validation component 742 may include any method for extracting data including, for example and without limitation, parsing, natural language processing, and manual extraction by a user such as user 201. Data extraction and validation component 742 may similarly use any suitable method for validating data including, for example and without limitation, validating the source and structure of data. Normalization component 744 may include any method of normalizing data collected by data collection system 730. Accordingly, data processing system 740 may duplicate or otherwise be substantially similar to methods applied by processing methods 530 (shown in FIG. 5).

Data processed by data processing system 740 is scored by scoring system 750. Scoring system 750 includes a math logic component 752, a business score component, 754, and a technical score component 756. Math logic component 752 extracts normalized data and uses formulas to produce output which can be used by business score component, 754, and a technical score component 756. In other words, math logic component 752 processes data processed by data processing system 740 to allow for the computation of business scores and technical scores by business score component 754 and technical score component 756. Scoring system 750 may duplicate or otherwise be substantially similar to dynamic scoring system 535 (shown in FIG. 5).

Output generated by scoring system 750 is received by online PMF platform 760 and, more specifically, by online content module 762. Online content module 762 calls a plurality of functions to facilitate the presentation of technological maturity data including data calculated by business scores component 754 and technical scores component 756. More specifically, online content module 762 invokes at least one of an HTML creation module 764, a JavaScript scripting module, and proprietary chart API call module 766 to generate online content. Additionally, online content module 762 may invoke any other method suitable for generating content to present technological maturity data including, for example and without limitation, Ajax modules, Ruby modules, and Python modules.

Content generated by online PMF platform 760 and, more specifically, online content module 762 is present by publication platform 770 and, more specifically, publication module 772. Publication module 772 is a module which allows for the serving of content generated by online PMF platform 760. Accordingly, publication platform 770 may include, for example, web servers, database servers, and application servers to facilitate the publication of online content generated by online content module 762.

Although diagram 700 indicates survey platform 710, survey distribution system 720, data collection system 730, data processing system 740, scoring system 750, online PMF platform 760, and publication platform 770 as distinct system and platforms, all such systems and platforms may be hosted on a single TME computer device 114 (shown in FIG. 5). Alternately, all such platforms and systems may be hosted on a plurality of TME computer devices 114.

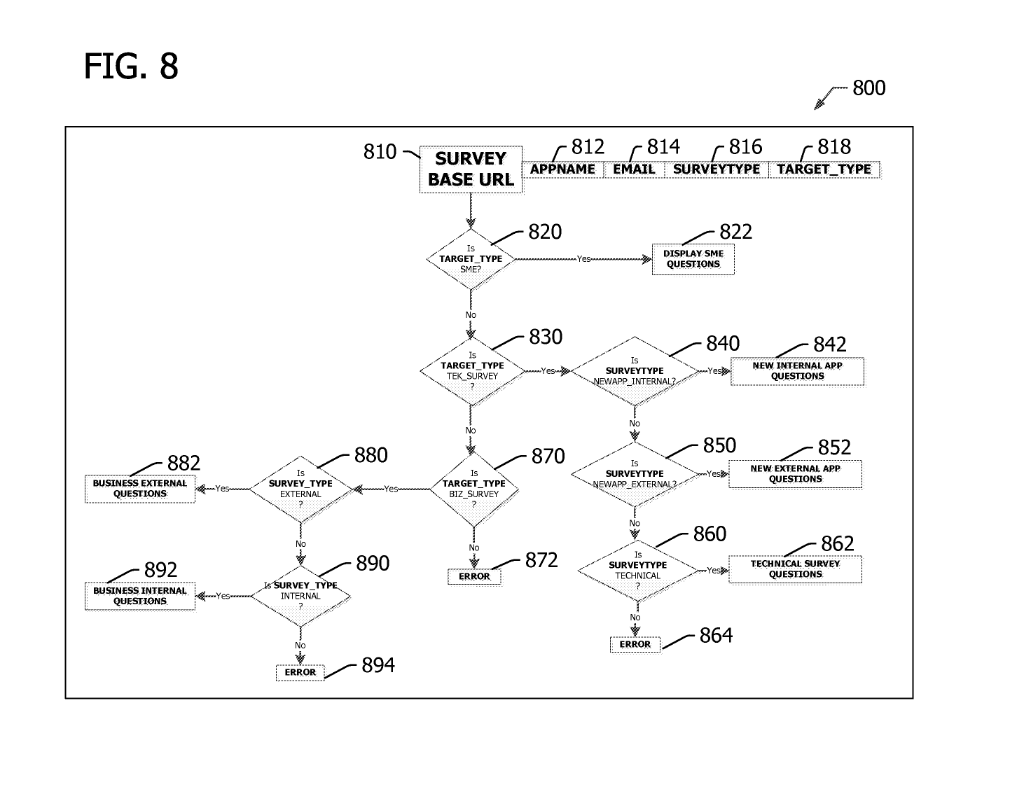

FIG. 8 is an example process flow diagram 800 illustrating a method of generating survey questions 610 (shown in FIG. 6) for display to a subject matter expert (SME) on TME computer device 114 (shown in FIG. 5). In other words, method 800 facilitates As described in FIG. 7, surveys 722 (shown in FIG. 7) are associated with unique URLs. In the example embodiment, each URL associated with each survey 722 may include a survey base URL 810. Survey base URL 810 is a static URL which may be followed by a plurality of variable URL components including an application name 812, an email address 814, a survey type 816, and a target type 818. In other words, the URL associated with each survey 722 includes a reference to at least one of application name 812, email address 814, survey type 816, and target type 818. Application name 812 and email address 814 may be used by a survey presentation server (not shown) to display content related to the application title or the SME responding to survey 722. Survey type 816 and target type 818 determine whether survey 722 is a technical survey, a business survey, or a SME survey.

Accordingly, the logic of diagram 800 assesses the values of the URL components to indicate how to present survey 722. Boolean 820 determines whether target type 818 references “SME”. If target type 818 does reference “SME”, TME computer device 114 displays SME questions 822. If target type 818 does not reference “SME”, Boolean 830 determines whether target type 818 references “TEK_SURVEY”. If target type 818 references “TEK_SURVEY” and survey type 816 references “NEWAPP_INTERNAL”, Boolean 840 causes TME computer device 114 to display new internal application questions 842. If target type 818 references TEK_SURVEY” and survey type 816 references “NEWAPP_EXTERNAL”, Boolean 850 causes TME computer device 114 to display new external application questions 852. If target type 818 references TEK_SURVEY” and survey type 816 references “TECHNICAL”, Boolean 860 causes TME computer device 114 to display technical survey questions 862. If target type 818 references TEK_SURVEY” and survey type 816 references neither “NEWAPP_EXTERNAL”, “NEWAPP_INTERNAL”, nor “TECHNICAL”, Boolean 860 causes TME computer device 114 to indicate an error 864.

If target type 818 does not reference “TEK_SURVEY”, Boolean 870 determines whether target type 818 references “BIZ_SURVEY”. If target type 818 does not reference “SME”, “TEK_SURVEY”, nor “BIZ_SURVEY”, Boolean 870 causes TME computer device 114 to indicate an error 872. If target type 818 references “BIZ_SURVEY” and survey type 816 indicates “SURVEY_TYPE_EXTERNAL”, Boolean 880 causes TME computer device to display external business questions 882. If target type 818 references “BIZ_SURVEY” and survey type 816 indicates “SURVEY_TYPE_INTERNAL”, Boolean 890 causes TME computer device to display internal business questions 892. If target type 818 references “BIZ_SURVEY” and survey type 816 indicates neither “SURVEY_TYPE_INTERNAL” nor “SURVEY_TYPE_EXTERNAL”, Boolean 890 causes TME computer device to display error 894.

Accordingly, diagram 800 illustrates a method of processing a URL associated with surveys 722 to generate a specific set of questions to display to a user. However, surveys 722 may be generated with any other method which allows users 201 to receive survey questions 610 (shown in FIG. 6) to facilitate the systems and methods described.

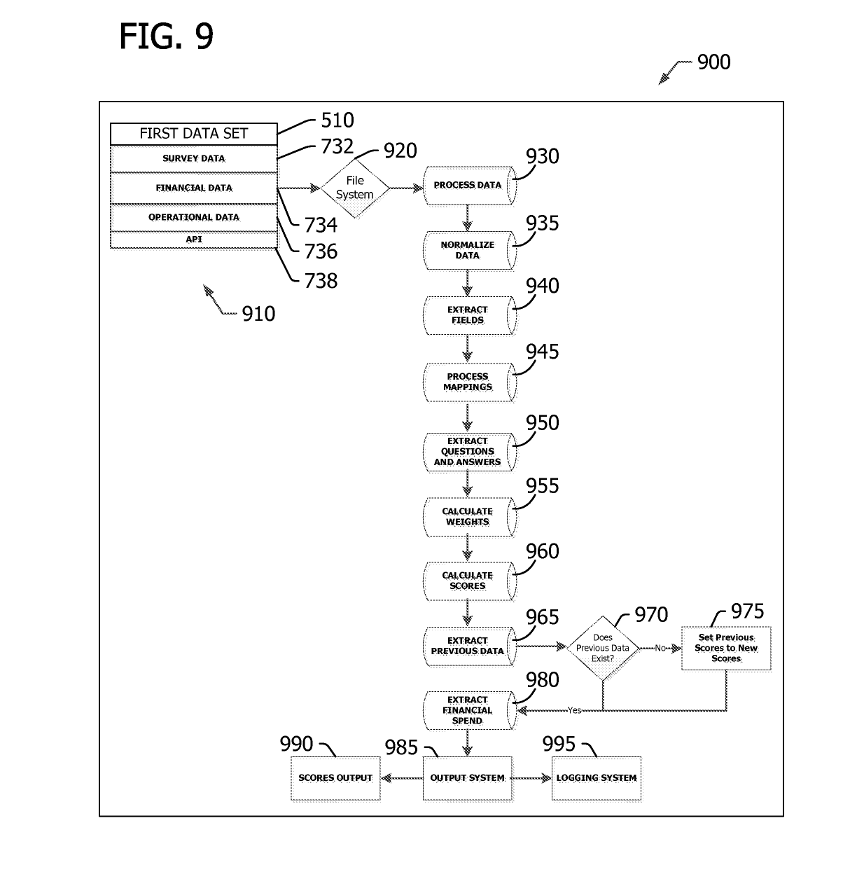

FIG. 9 is an example data flow diagram showing a method 900 of scoring data including TME data 520 and first data set 510 using dynamic scoring system 535 to generate business scores 546 and technical scores 548 (all shown in FIG. 5). Method 900 is implemented by TME computer device 114 (shown in FIG. 5). In alternative examples, method 900 may alternately be implemented by TEM computer device 121 (shown in FIG. 5). In the example embodiment, TME computer device 114 receives a plurality of data 910 including first data set 510, survey data 732, financial systems data 734, operational metrics data 736, and API data 738. Data 910 substantially represents first data set 510, survey data 732, financial systems data 734, operational metrics data 736, and API data 738 as described in FIGS. 5 and 7. Data 910 (i.e., at least one of first data set 510, survey data 732, financial systems data 734, operational metrics data 736, and API data 738) is written to file system 920 which may be stored, for example, in memory 310 (shown in FIG. 4). Accordingly, receiving data 910 and writing to file system 920 may be performed by data collection system 730 (shown in FIG. 7).

TME computer device 114 processes data 930, normalizes data 935, extracts fields 940, maps processes 945, and extracts questions and answers 950 from data 910. Accordingly, steps 930, 935, 940, 945, and 950 may represent steps executed by data processing system 740 (shown in FIG. 7).

TME computer device 114 calculates weights 955 and calculates scores 960 associated with processed, normalized data. The process of calculating weights 955 and calculating scores 960 is described further below. Steps 955 and 960 may represent steps executed by scoring system 750 (shown in FIG. 7) and dynamic scoring system 535 (shown in FIG. 5).

TME computer device 114 additionally attempts to extract previous data 965. If TME computer device 114 determines, by Boolean 970, that previous data exists, previous data and, more specifically, financial spend data is extracted 980. If no previous data exists, Boolean 970 causes TME computer device 114 to set previous score data to new score data 975. In other words, the scores determined in calculating weights 955 and calculating scores 960 are set as the previous scores for future technological asset evaluation.

Output generated based upon steps 955, 960, 965, and 980 is generated by output system 985. Accordingly, output system 985 may substantially represent online PMF platform 760 (shown in FIG. 7) and online content module 762 (shown in FIG. 7). Output system 985 specifically may generate scores output 990 and write records to logging system 995. Scores output 990 may be represented as any of evaluation output 540 (shown in FIG. 5). Logging system 995 represents a historical log file tracking at least business scores 546 and technical scores 548 associated with an asset.

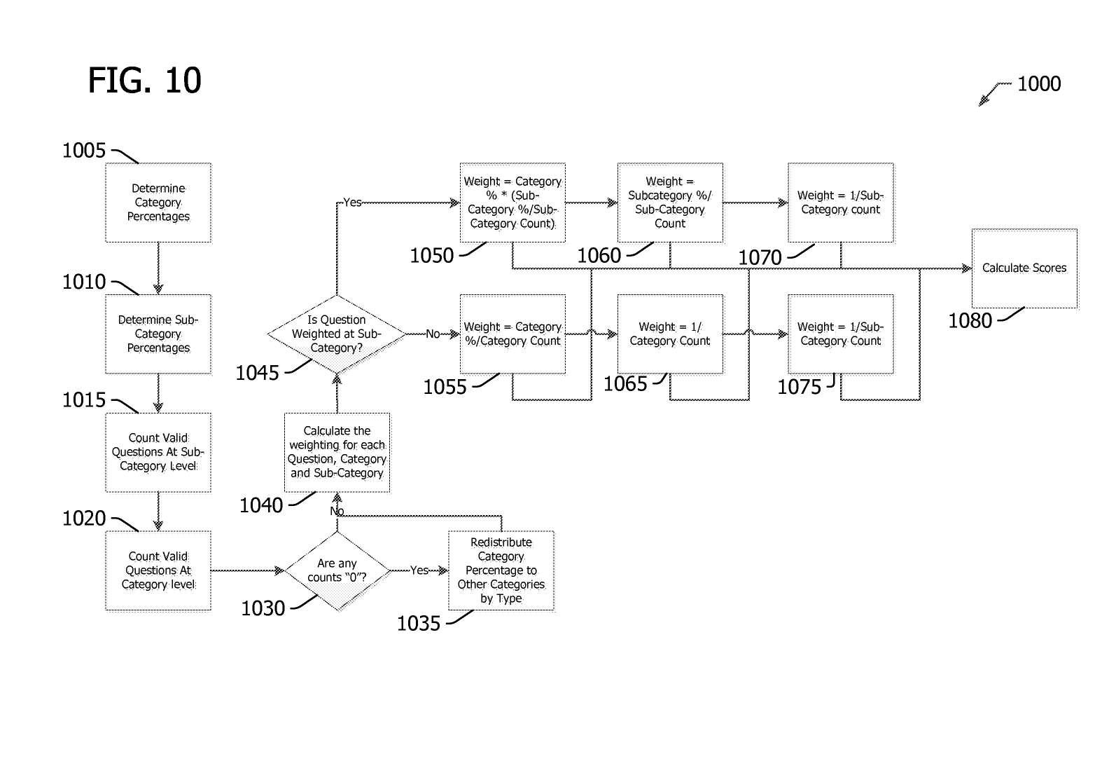

FIG. 10 is an example process flow diagram illustrating a method 1000 of applying weights to applications which may be used by the dynamic scoring system 535 and evaluation function 531 of FIG. 5. Method 1000 may be implemented by TME computer device 114 (shown in FIGS. 1 and 2). TME computer device 114 determines category percentages 1005 and determines sub-category percentages 1010. Determined category percentages 1005 and determined sub-category percentages 1010 represent weighting percentages received by TME computer device 114 from, for example, user 201 (shown in FIG. 3). Determined category percentages 1005 and determined sub-category percentages 1010 may be provided at an application where user 201 determines the significance of particular criteria. For example, a database application may require high availability and may accordingly have a determined category percentage 1005 of “55%” for availability. Alternately, the database application may be used primarily by experts and have a low determined category percentage 1005 of “5%” for customer delivery. Determined sub-category percentages 1010 may be weighted in a similar fashion. In some examples, determined category percentages 1005 and determined sub-category percentages 1010 may be provided by a plurality of users 201 or external computer systems (not shown).

TME computer device 114 determines which questions from survey 722 (shown in FIG. 7) are responsive to categories and sub-categories and accordingly counts valid questions at sub-category level 1015 and counts valid questions at category level 1020. TME computer device 114 can process such question counts with the determined weight percentages to calculate scores 1080. TME computer device 114 may determine whether any counts for a category or sub-category are “0” using Boolean 1030. Boolean 1030 accordingly checks whether survey 722 does not include any questions responsive to a particular category or sub-category. If Boolean 1030 determines no questions are responsive to a particular category or sub-category, TME computer device 114 redistributes category percentages to other categories by type 1035. In other words, if no questions are associated with a particular category or sub-category in survey 722, TME computer device 114 distributes determined category percentages 1005 and determined sub-category percentages 1010 to different categories and sub-categories. Accordingly, TME computer device 114 attempts to preserve the intent of the determined category percentage 1005 and determined sub-category percentages 1010.

TME computer device 114 checks whether any question in survey 722 is weighted at a sub-category level using Boolean 1045. If TME computer device 114 determines, using Boolean 1045, that any question in survey 722 is weighted at a sub-category level, weight percentages are calculated according to steps 1050, 1060, and 1070. Alternately, if Boolean 1045 determines that questions in survey 722 are not weighted at a sub-category level, weight percentages are calculated according to steps 1055, 1065, and 1075. The calculations of weight provided by steps 1050, 1055, 1060, 1065, 1070, and 1075 are used by TME computer device 114 to calculate scores 1080. Calculating scores 1080 represents calculating at least one of business scores 754 (shown in FIG. 7) and technical scores 756 (shown in FIG. 7).

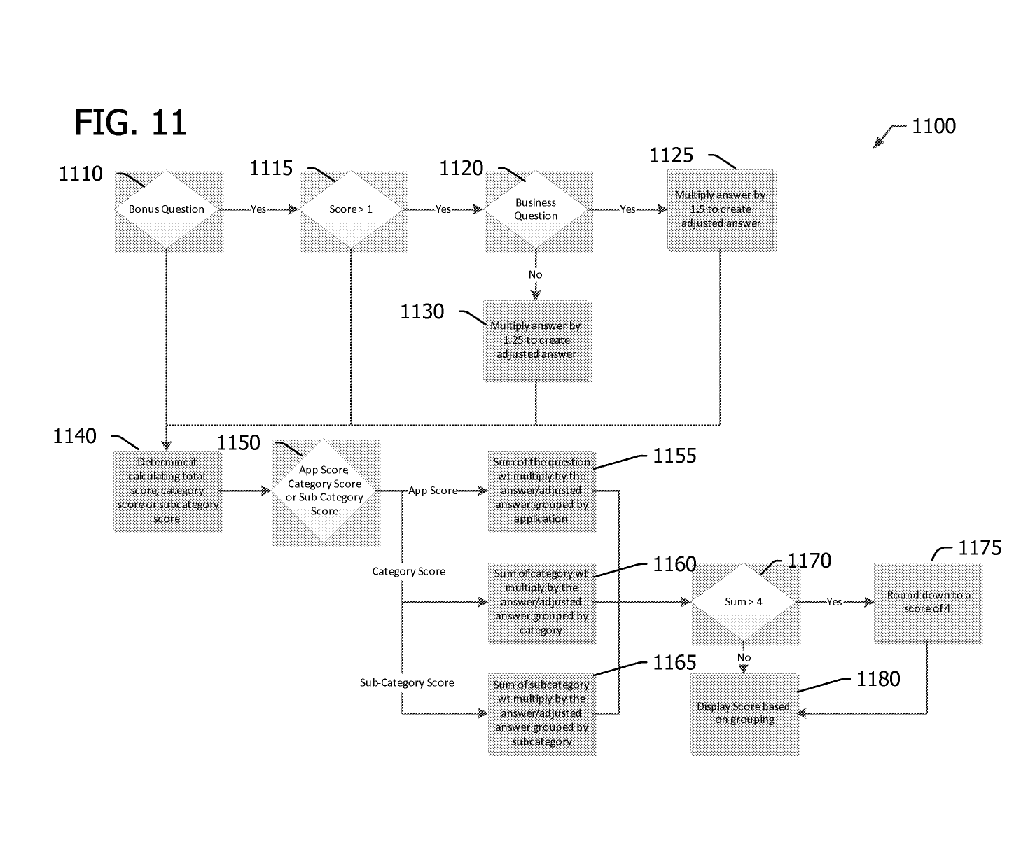

FIG. 11 is an example process flow diagram illustrating a method 1100 for calculating business score 546 and technical score 548 (shown in FIG. 5). Method 1100 is implemented by TME computer device 114 (shown in FIGS. 1 and 2). Method 1100 is an example method for calculating business score 546 and technical score 548 and any other method may be used to facilitate the systems and methods described herein. TME computer device 114 identifies whether a question from survey 722 (shown in FIG. 7) is a bonus question using Boolean 1110. If Boolean 1110 determines that a question from survey 722 is a bonus question and Boolean 1115 determines that a score associated with the question is non-zero, the response to the question may be weighted more significantly than a non-bonus question. Boolean 1120 determines whether the question is a business question. If the bonus question is determined by Boolean 1120 to be a business question, the response to the question is multiplied by a factor of “1.5” to create a first adjusted answer 1125. If the bonus question is determined by Boolean 1120 to not be a business question, the response to the question is multiplied by a factor of “1.25” to create a second adjusted answer 1130.

TME computer device 114 determines 1140 if the score calculated is a total score, a category score, or a sub-category score. Accordingly, TME computer device 114 uses determining step 1140 to decide 1150 whether to use application score calculation 1155, category score calculation 1160, or sub-category score calculation 1165. After deciding 1150, TME computer device 114 applies at least one of application score calculation 1155, category score calculation 1160, or sub-category score calculation 1165 to data from survey 722. In some examples, if the calculated score is determined to exceed a particular value, Boolean 1170 may truncate the value by rounding it down. In the example embodiment, Boolean 1170 may determine that scores over a value of four are rounded down 1175 to a value of four. Once calculated scores are determined, they are displayed based on score grouping 1180 by TME computer device 114.

FIG. 12A is a data flow diagram showing a process 1200A implemented by the TEM computer device 121 (shown in FIGS. 1 and 2) for evaluating technology assets in accordance with one embodiment of the present invention. TEM computer device receives 1210 a first data set. Receiving 1210 a first data set represents TEM computer device 121 receiving first data set 510 (shown in FIG. 5) from a plurality of data sources 515 (shown in FIG. 5). Receiving 1210 may also include receiving data feed 517 (shown in FIG. 5) from data sources 515. Receiving 1210 may additionally include receiving TME data 520 (shown in FIG. 5) from a TME computer device 114 (shown in FIG. 5) or polling for TME data 520 directly.

TEM computer device 121 determines 1220 at least one evaluation function and at least one categorization function to apply to first data set 510. Determining 1220 represents TEM computer device 121 identifying evaluation function 531 and categorization function 533 (both shown in FIG. 5) to apply to first data set 510. Determining 1220 may represent calling evaluation function 531 and categorization function 533 from memory 210 (shown in FIG. 3), retrieving evaluation function 531 and categorization function 533 from database 120 (shown in FIG. 1), or receiving evaluation function 531 and categorization function 533 with first data set 510. In other words, determining 1220 represents determine a context of the first technology asset with categorization function 533 and determining a quantitative evaluation of the first technology asset with the evaluation function 531 based on first data set 510 and the context of the first technology asset.

TEM computer device 121 processes 1230 first data set using the at least one evaluation function and the at least one categorization function to determine Processing 1230 represents applying evaluation function 531 and categorization function 533 to first data set 510.

TEM computer device 121 generates 1240 at least one evaluation output based upon the second data set, wherein the evaluation output represents an output indicating the technological evaluation of the first technology asset. Generating 1240 represents TEM computer device 121 generating evaluation output 540 (shown in FIG. 5) to evaluate the first technology asset.

FIG. 12B is a data flow diagram 1200B showing a process implemented by the TME computer device 114 (shown in FIGS. 1 and 2) for evaluating technology assets in accordance with one embodiment of the present invention. In the example embodiment, TME computer device 114 evaluates software applications. In alternate embodiments, TME computer device 114 may evaluate any assets capable of being evaluated by business value and/or technical maturity. TME computer device 114 compares pre-determined assets by determining a business value score and a technical maturity score for each pre-determined asset. TME computer device 114 uses the business value and technical maturity scores to display a graph showing the technical maturity of each asset relative to the other assets evaluated. Business value represents an overall value and impact an asset has in a market, including the amount of business and revenue the asset generates. Technical maturity represents an amount of resources and processes that the company has invested to develop and implement the asset's technology. Taken together, determining the business value and the technical maturity of an asset provides a realizable assessment that can be used to compare the assets and identify the strengths and weaknesses of each asset relative to the others.

Referring to FIG. 12B, during operation, a plurality of assets are inputted 1250 for TME computer device 114 to compare. The assets are selected by a user, such as user 201. User 201 may also be referred to as analyst 201. Analyst 201 uses a computer device, such as user computer device 154 (shown in FIG. 2), to interface with and operate TME computer device 114. In the example embodiment, TME computer device 114 is stored on a server, for example, server 112 (shown in FIGS. 1 and 2).

For the specified assets to be evaluated, TME computer device 114 provides 1260 a plurality of questions relating to the business value and the technical maturity of the asset. The business value questions are associated with different categories related to the business. In the example embodiment, the business questions include volume, exposure, profitability, and expected growth. In an alternate embodiment, the business questions may include any inquiries that enable the business value of an asset to be determined as described herein. The technical maturity questions are associated with the operability and capability of the technology used to implement the asset. In the example embodiment, the technical questions include categories related to reliability, availability, maintainability, customer delivery, and process governance. In an alternate embodiment, the technical questions may include any inquiries that enable the technical maturity of an asset to be determined as described herein.

To provide an accurate evaluation of assets, objectivity in the responses to the questions is desirable. To achieve objectivity, TME computer device 114 (i) poses or displays the same questions for each asset, regardless of its purpose or size of operation, (ii) poses or displays the questions to specific subject matter experts, wherein a subject matter expert is one with appropriate business or technical knowledge to accurately answer the questions (i.e. business analysts/executives answer business value questions and technology managers answer technical maturity questions and technical subject matter experts answer questions related to their fields of expertise), and (iii) provides multiple-choice answers to each question to enable multiple-tier analysis for differentiation in the scoring of the assets. The answers provide a scale of maturity and/or value starting with the lowest maturity and/or value for a specific question. In the example embodiment, each multiple-choice question has four answers. In an alternate embodiment, each question may have a “yes” or “no” answer. In other alternate embodiments, each question may have any number of answers that enables TME computer device 114 to function as described herein. In some embodiments, TME computer device 114 may include specific batches of questions for different types of assets. For example, TME computer device 114 may provide a first batch of identical questions for assets configured for customer use, while TME computer device 114 may provide a second batch of identical questions for internal assets of the company. In designing the questions, the appropriate subject matter expert is identified with each question, enabling TME computer device 114 to provide the questions to the appropriate person or group. TME computer device 114 provides the questions via server system 112 (shown in FIGS. 1 and 2) to the subject matter expert, who uses a user computer device, such as user computer device 154 (shown in FIG. 2), to interface with TME computer device 114.

Upon submission of the answers by the subject matter experts, TME computer device 114 receives 1270 the answers to the questions, which is referred to as “response data”. In the example embodiment, TME computer device 114 stores the response data in a database so that it can be accessed in the future for other comparisons and/or analysis. TME computer device 114 then scores 1280 each asset based on the response data. For example, TME computer device 114 determines a business value score and a technical maturity score for each asset. For scoring purposes, each question may be weighted by importance, so that when comparing multiple assets, certain characteristics may be highlighted, or given more weight, to reflect importance or significance thereof. The questions may have separate categories and sub-categories (i.e., technical reliability may include scalability, versioning, testing, process, security, etc.), which also may be separately weighted. The categories and sub-categories of the questions assist in analyzing assets by determining scores for specific aspects of the assets, so that strengths and weaknesses relating to technical maturity can be determined for specific areas.

TME computer device 114 then generates 1290 a graphical representation for comparing the analyzed assets relative to one another. The graph displays a point, or bubble, representing each evaluated asset. In the example embodiment, the business value is represented on the vertical axis and the technical maturity is represented on the horizontal axis. The graph enables analyst 201 to look at the technical maturity of an asset and assess the areas where the asset's technology is adequate, and where it is lacking relative to its business value.

Each asset on the graph may be selected by analyst 201 to view detailed scores at the category and sub-category levels, as well as a recommendation of a planned action to take for the asset created by TME computer device 114. The graph may also be displayed at a platform level, where a platform represents a plurality of assets associated with a specific division or business aspect of the company. For example, the graph at the platform level may indicate an overall maturity of multiple assets for a division and how that maturity relates to the business value of the division and platforms of other divisions.

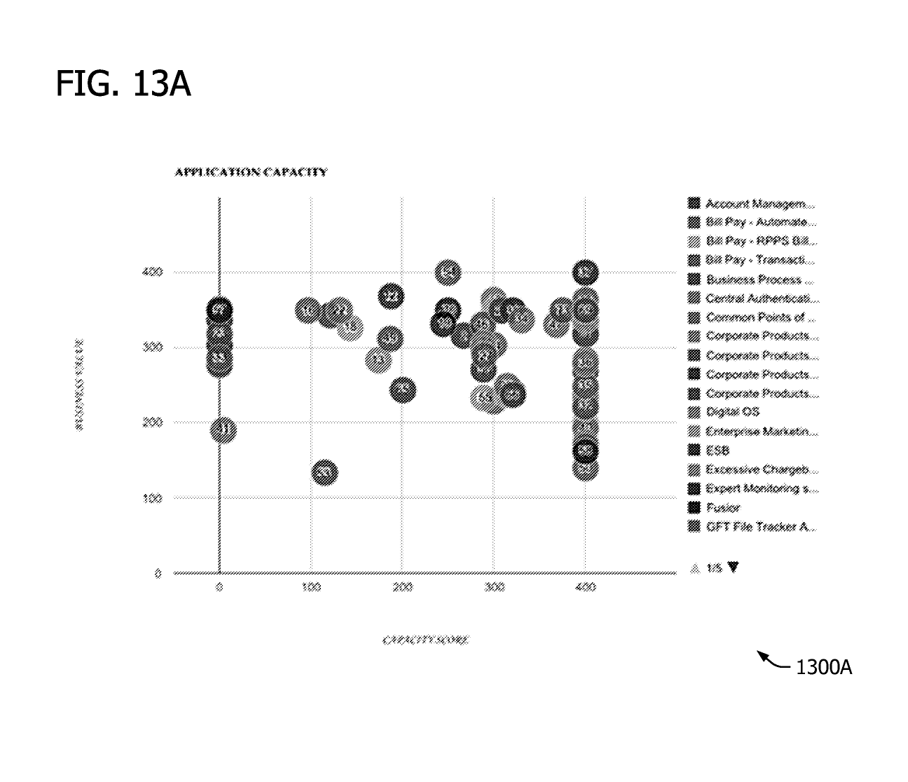

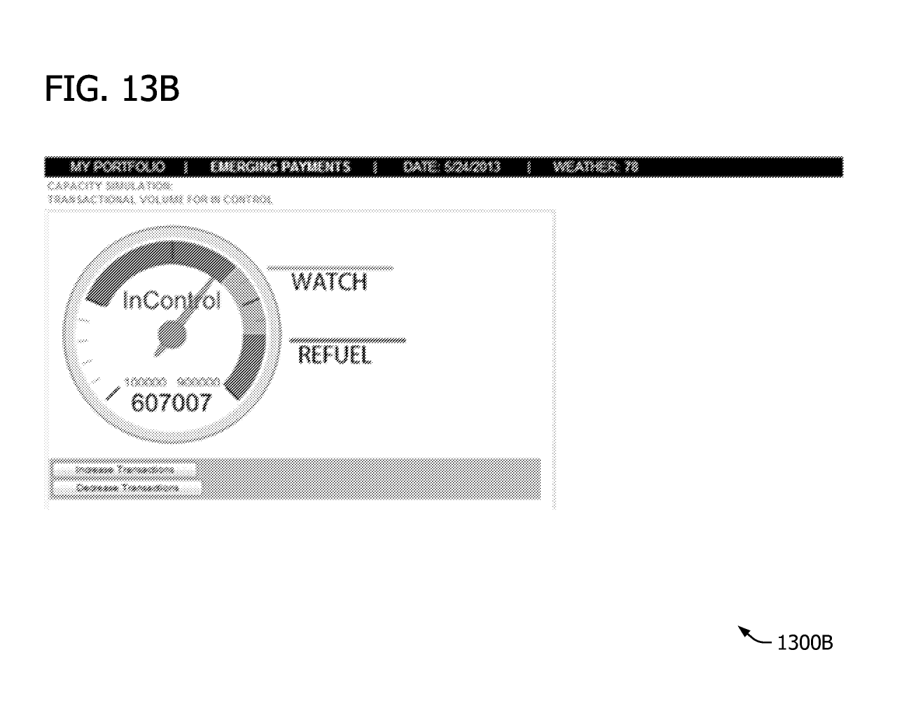

FIG. 13A is a screenshot 1300A of a first evaluation output 540 (shown in FIG. 5) produced by TEM computer 121 (shown in FIGS. 1 and 2). Screenshot 1300A may be accessed via a user computer, such as user computer device 154 (shown in FIG. 2). Screenshot 1300A represents a first example of resource capacity output 541. Resource capacity output 541 shows a scored capacity rating for a plurality of technology assets along with their respective business values. More specifically, the x-axis of screenshot 1300A indicates a capacity score while the y-axis of screenshot 1300A indicates a business value. The bubbles indicated on the graph of screenshot 1300A indicate various business/capacity characteristics of technology assets indicated by each bubble.

Resource capacity output 541 facilitates assessing, for example, where mission critical technology assets are under-provisioned and where low value technology assets are over-provisioned. Such a projection can assist in technology evaluation decisions. In screenshot 1300A, for example, bubble 50 has a high capacity score of “400” with a low business value just above “100”. Alternately bubble 67 has a high business value of “350” with a capacity score of “0”. Accordingly, greater investment in the technology asset represented by bubble 67 and lesser investment in the technology asset represented by bubble 50 may be desired. Resource capacity output 541 facilitates this determination and the resulting operational action.

FIG. 13B is a screenshot 1300B of a second evaluation output 540 (shown in FIG. 5) produced by TEM computer 121 (shown in FIGS. 1 and 2). Screenshot 1300B may be accessed via a user computer, such as user computer device 154 (shown in FIG. 2). Screenshot 1300B represents a second example of resource capacity output 541 (shown in FIG. 5).

In screenshot 1300B, resource capacity output 541 represents a display indicating the state of resource capacity for a particular technology asset. More specifically, resource capacity output 541 indicates whether a particular technology asset is over-provisioned, properly provisioned, or under-provisioned based upon a projection of business activity related to the technology asset. The visualization associated with the example further indicates whether the technology asset should be “watched” or “refueled”. In the example, resource capacity output 541 indicates that the technology asset is approaching the “watch” region. Accordingly, monitoring the technology asset for potential capacity issues may be desirable. Resource capacity output 541 facilitates this determination and the resulting operational action.

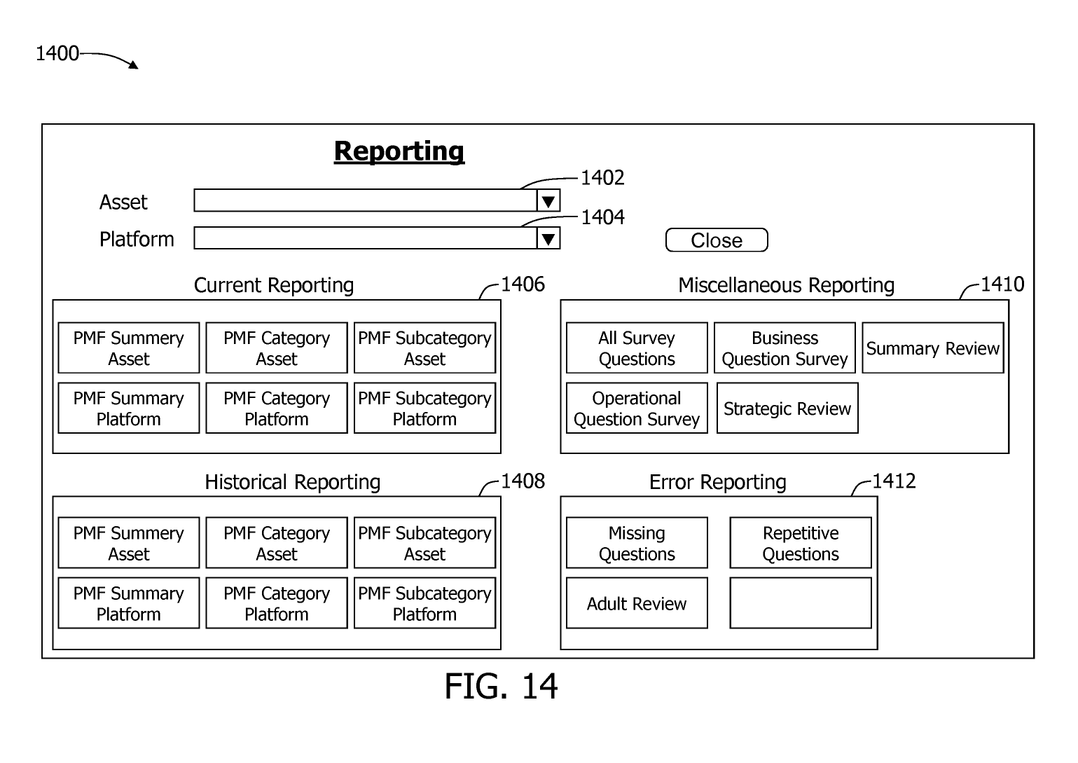

FIG. 14 is a screenshot of a reporting screen 1400 from TME computer device 114 (shown in FIGS. 1 and 2) in accordance with an example embodiment of the present invention. Reporting screen 1400 may be accessed via a user computer, such as user computer device 154 (shown in FIG. 2). In the example embodiment, reporting screen 1400 includes an asset drop down menu 1402, a platform drop down menu 1404, a current reporting section 1406, a historical reporting section 1408, a miscellaneous reporting section 1410, and an error reporting section 1412. Asset menu 1402 and platform menu 1404 enable a user to choose specific assets or platforms associated with a company or a portfolio. If no specific asset or platform is chosen from menus 1402 or 1404, TME computer device 114 evaluates all assets and platforms.

Current reporting section 1406 and historical reporting section 1408 enable a user to analyze the business value scores and the technical maturity scores calculated by TME computer device 114. Sections 1406 and 1408 include identical options and will be described together, except current reporting section 1406 provides analysis of the most current data, while historical reporting section 1408 provides analysis for past data collections. In the example embodiment, sections 1406 and 1408 each include options that provide the following: a summary at asset level, a summary at platform level, an asset summary at category level, a platform summary at category level, an asset summary at sub-category level, and a platform summary at sub-category level.

The summary at asset level option provides the business value and technical maturity scores calculated by TME computer device 114 for assets associated with a company or a portfolio. As described above, a user may select one or more specific assets for viewing using asset menu 1402. If no asset is chosen, scores for all assets are provided.

The summary at platform level option provides the business value and technical maturity scores calculated by TME computer device 114 for platforms associated with a company or a portfolio. As described above, an analyst may select one or more specific platforms for viewing using platform menu 1404. If no platform is chosen, the scores for all platforms are provided. If the user does not know the name of a particular platform to be analyzed, the user may select an asset and TME computer device 114 provides a list of each platform that the asset impacts.

The asset summary at category level option provides the business value and technical maturity scores for an asset, separated by category. As described above, a user may select one or more specific assets for viewing using asset menu 1402. If no asset is chosen, the scores for all assets are provided.

The platform summary at category level option provides the business value and technical maturity scores for a platform, separated by category. As described above, a user may select one or more specific platforms for viewing using platform menu 1404. If no platform is chosen, the scores for all platforms are provided.

The asset summary at sub-category level option provides the business value and technical maturity scores for an asset, separated by sub-category. As described above, a user may select one or more specific assets for viewing using asset menu 1402. If no asset is chosen, the scores for all assets are provided.

The platform summary at sub-category level option provides the business value and technical maturity scores for a platform, separated by sub-category. As described above, a user may select one or more specific platforms for viewing using platform menu 1404. If no platform is chosen, the scores for all platforms are provided.

Miscellaneous reporting section 1410 enables a user to provide and/or review the questions presented to the subject matter experts for determining business value and technical maturity scores. Miscellaneous reporting section 1410 includes options that provide: all survey questions, operational questions, business questions, strategic review, and summary review.

The all survey questions option provides a report that includes all active questions that may be sent to the subject matter experts. The operational question survey option provides a report that includes all active technical maturity questions. If an asset or a platform is chosen from either menu 1402 or 1404, then only technical maturity questions relating to the selection are displayed. The business value question survey option provides a report that includes all active business value questions. If an asset or a platform is chosen from either menu 1402 or 1404, then only business value questions relating to the selection are displayed.

The strategic review option provides the percentage of assets associated with each multiple-choice question. In the example embodiment, each multiple-choice question has four answers and the strategic review option provides the percentage of assets associated with each answer 1-4. The summary review option provides data used to populate a grid matrix.

Error reporting section 1412 provides options for the user to report errors or inconsistencies with TME computer device 114. The options include: missing questions, audit review, and repetitive questions. The missing questions and repetitive options enable a user of TME computer device 114 to provide notification of any questions that are missing or repetitive. A manager of TME computer device 114 receives the notifications and determines how to remedy the issues. The audit review option assists in creating the metrics of TME computer device 114 during an audit cycle.

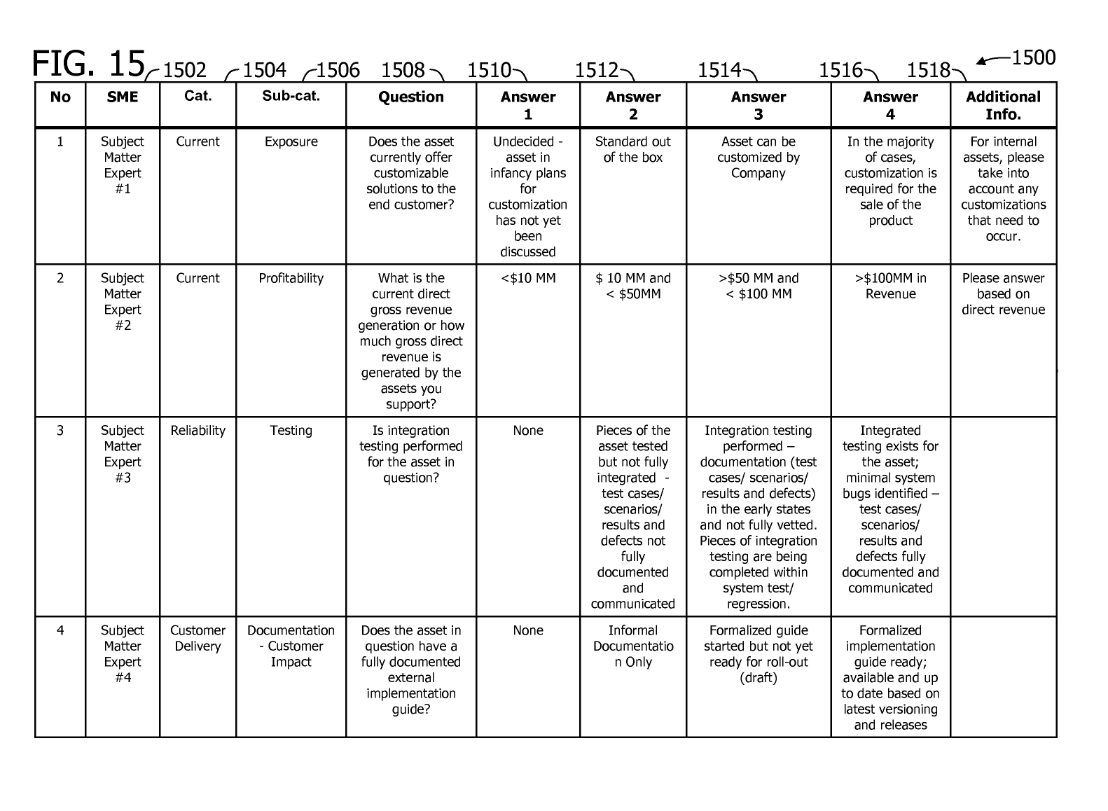

FIG. 15 is a chart 1500 illustrating exemplary questions and answers posed to subject matter experts by TME computer device 114 (shown in FIGS. 1 and 2) in accordance with one embodiment of the present invention. In the exemplary embodiment, TME computer device 114 includes an individual responsible column 1502, a question category column 1504, a sub-category column 1506, a question column 1508, an answer 1 column 1510, an answer 2 column 1512, an answer 3 column 1514, an answer 4 column 1516, and an additional information column 1518. Chart 1500 can be viewed by analyst 201 (shown in FIG. 3) by accessing the “all survey questions” option on reporting screen 1400 (shown in FIG. 14). In some embodiments, chart 1500 may be sorted by a specified column for a detailed analysis by analyst 201.

In the example embodiment, individual responsible column 1502 includes the subject matter expert having the appropriate knowledge regarding a particular aspect of the asset to answer a particular question. For each question, category column 1504 includes a category related to business value or technical maturity that each question is associated with. In the example embodiment shown in FIG. 9, question numbers 1 and 2 are associated with the category “current”, which is a category relating to the current business value of the asset. Questions may also be associated with a category “future”, which requires the subject matter expert to project an answer regarding an asset's value or performance a given number of months and/or years in the future. Question numbers 3 and 4 are associated with the categories “reliability” and “customer delivery”, which are categories relating to the technical maturity of the asset.

Sub-category column 1506 is a more specific version of category column 1504. In the example embodiment, question numbers 1 and 2 are associated with the sub-categories “exposure” and “profitability”, respectively, and are both business value sub-categories of the “current” category described above. Question number 3 is associated with the sub-category “testing”, which is a technical maturity sub-category that is associated with the category “reliability”. Question number 4 is associated with the sub-category “documentation—customer impact”, which is a technical maturity sub-category that is associated with the category “customer delivery”.

Question column 1508 includes the actual questions posed to the subject matter experts. Answer columns 1510, 1512, 1514, and 1516 include each of the multiple-choice answers to the questions. The answers assist in enabling consistency and objectivity for the subject matter experts who answer the questions so accurate evaluation of assets may occur. Additional information column 1518 may include information and/or explanation for a question to assist the subject matter expert to properly answer the question.

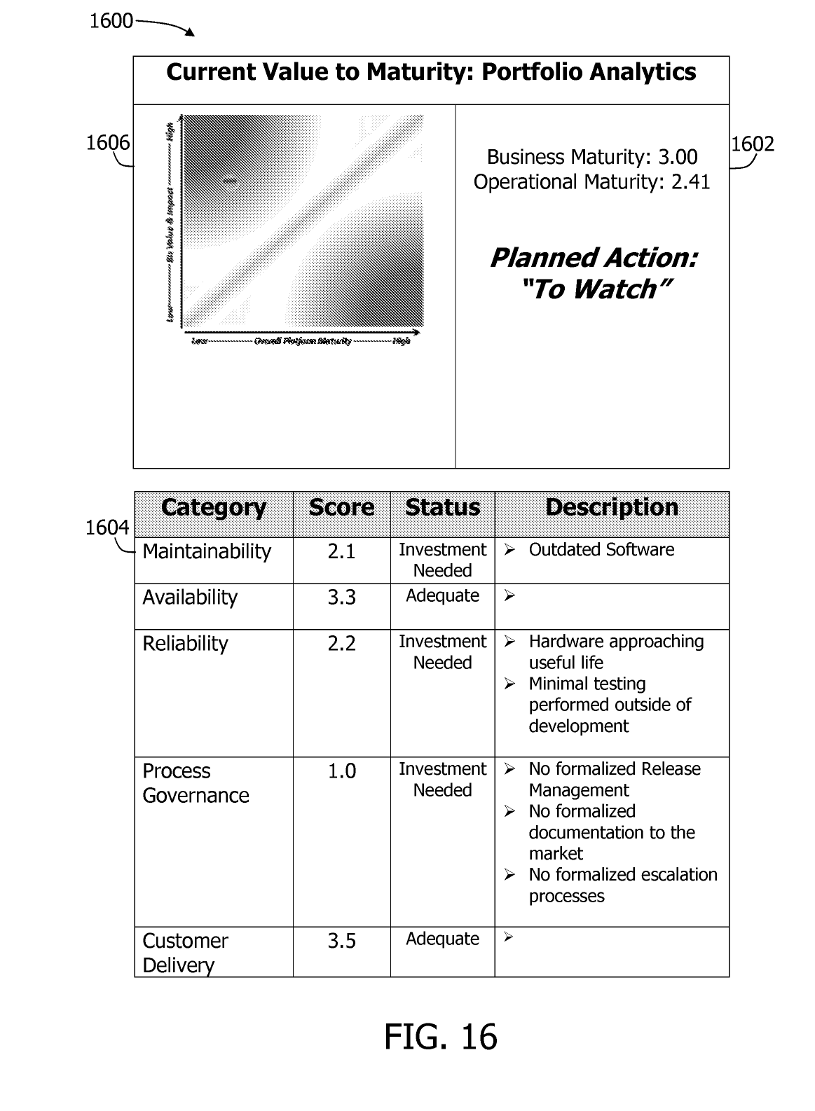

FIG. 16 shows an example summary report at asset level 1406 (shown in FIG. 14) as outputted by TME computer device 114 (shown in FIGS. 1, 2, and 8) in accordance with the present invention. In the example embodiment, analyst 201 (shown in FIGS. 3) using TME computer device 114 selects a specific asset to be analyzed from asset menu 1402 (shown in FIG. 14) and then selects the summary at asset level option from current reporting section 1406 (shown in FIG. 14). Included in summary 1600 is box 1602 that displays the asset's business value score, technical maturity score, and a planned action to take for the asset; box 1604 that contains a list of technical maturity categories being analyzed, and their associated scores, statuses, and descriptions; and box 1406 that contains a graphical representation of the business value of the asset relative to its technical maturity.

Box 1602 displays the business value score and the technical maturity score for the selected asset. Each score is calculated based on the response data provided by various subject matter experts, taking into consideration any weight added to certain questions. The specific values of the scores merely provide a basis for the scores to be compared to one another, and to other assets. The specific values also provide an indication of the disparity or relative alignment of the overall business value and/or technical maturity of the specific asset. An optimal state is to have the absolute difference between the business value and technical maturity scores approach zero. The optimal state is a level of investment in the technical maturity of the asset that is proportional with the business value derived from the asset.

Box 1602 also includes a planned action for the asset recommended by TME computer device 114. Specific planned actions may be specified by a user of TME computer device 114, and may be based on specific scoring levels for the asset. In the example embodiment, planned actions include “invest”, “watch”, and “balanced”. “Invest” indicates that the business value of the asset is much higher than the technical maturity, so the company needs to invest in technology to optimize the asset's value. “Watch” indicates that although the business value is higher than the technical maturity for an asset, they are relatively close in value. No major investment in the technology is immediately necessary, but the asset should be periodically reviewed to ensure the business value does not further exceed the technical maturity. “Balanced” indicates that the technical maturity is equal to or greater than the business value of the asset and no further investment is necessary. Other example actions are also possible if the technical maturity is greater than the business value. These example actions may include “kill”, “increase sales”, or “divest”. “Kill” indicates that the company should consider removing the asset. “Increase sales” indicates that the company should focus on increasing the business value of the asset by finding more opportunities to leverage the asset. “Divest” indicates that some of the technical complexity should be removed from the system, because it is not necessary.

Box 1604 includes a list of specific categories associated with the technical questions and provides the scores for each category. The score column indicates the areas of strength and weakness for specified categories of the asset. A status (i.e. “investment needed” or “adequate”) and a description of why the status is chosen are provided for each of the categories.

Box 1606 includes a graph illustrating the business value of the asset relative to the technical maturity. The graph includes a line spanning from the bottom-left corner of the graph to the top-right corner that indicates an optimum business value to technical maturity ratio for an asset. In the example embodiment shown in FIG. 16, the point representing the asset lies above the optimization line, indicating that the business value is greater than the technical maturity, as is detailed in box 1602. The graph includes a section near the line that is light in color. The asset's bubble being in this lightly-colored section indicates that the asset has an acceptable technical maturity. In an alternate embodiment, the graph may be provided in color. The darkest portions of the graph are red, which blends into orange and then yellow at the lightest points, while the optimization line is green. The color scheme serves as indication of very poor balance levels (i.e. red), slightly low balance levels (i.e. orange to yellow), and asset is balanced (i.e. green).

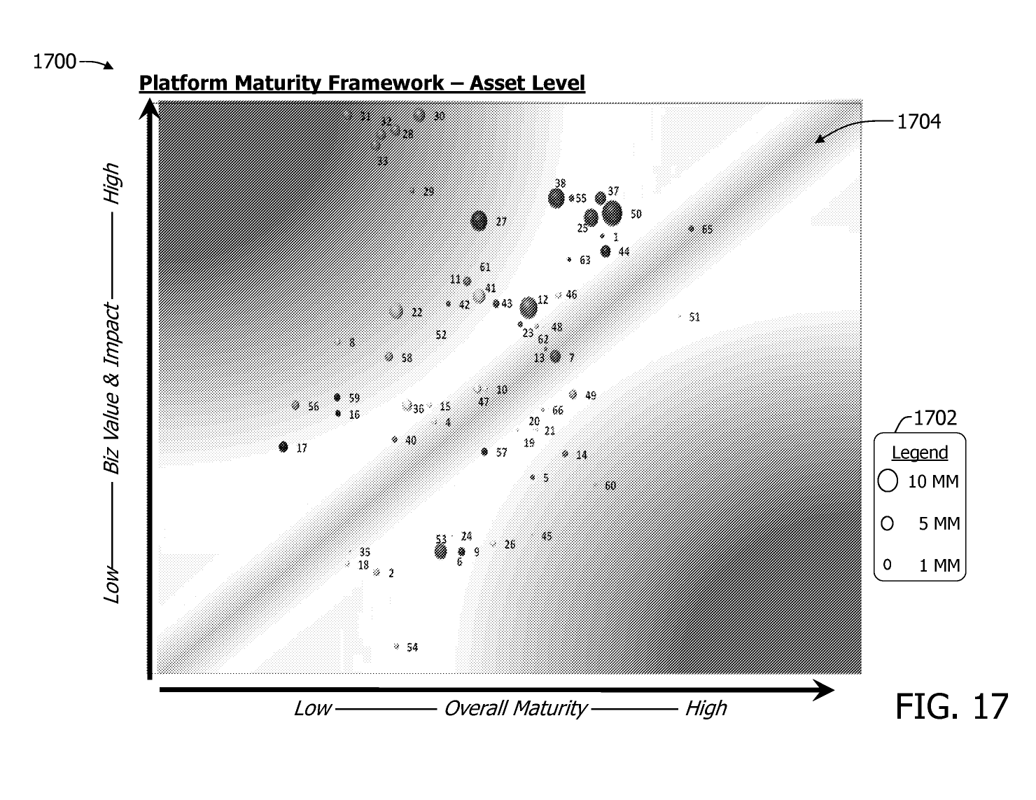

FIG. 17 is an example graph 1700 created by TME computer device 114 (shown in FIGS. 1 and 2) illustrating the maturity of a plurality of assets relative to one another. Graph 1700 includes a plurality of points, or bubbles (i.e., 1-66), that represent different assets and a list that identifies each point. In the example embodiment, sixty-six assets are compared; however, any number of platforms may be selected for comparison.

In the example embodiment, the bubbles on graph 1700 have different sizes and shades of color. The size of a particular bubble generally represents the amount of money the company is spending on a particular asset, which may be indicative of the overall importance of that asset to the company. In the example embodiment, a legend 1702 is included in graph 1700 to provide a reference of the amount of money being spent relative to the size of a bubble. For example, legend 1702 indicates that about $10 million is being spent on each of the assets associated with bubbles 22, 25, 41, and 53, while only about $1 million is being spent on the assets associated with bubbles 2, 8, 43, and 46. The bubbles also may be shaded to illustrate which assets are related to certain platforms or particular parts of the business. For example, darker shaded bubbles 1, 25, 37, 38, 44, 50, 55, and 65 all represent assets associated with one platform, while lighter shaded bubbles 28, 30, 31, 32, and 33 are assets associated with a different platform. In an alternate embodiment, graph 1700 and bubbles 1-66 may be provided in color to better represent their relationships. An analyst using TME computer device 114 may select a particular bubble on graph 1700 to see more details for an asset. For example, selecting a bubble may display the summary at asset level 1600 (shown in FIG. 16).

Graph 1700 enables the comparison of one or more assets associated with a company or portfolio by plotting each asset based on its business value relative to its technical maturity, while also illustrating which assets are related to different aspects of the business and the amount of money being spent on each asset. Graph 1700 includes an optimization line 1704 that indicates an ideal or optimized ratio of business value relative to technical maturity for an asset. For example, darker shaded bubbles 1, 25, 37, 38, 44, 50, 55, and 65 have a high business value and an almost equally high technical maturity. Viewing any of these assets in the summary at asset level 1600, TME computer device 114 would likely provide a planned action of “watch” or “balanced” because these assets are close to optimization line 1704 on graph 1700. This indicates that the amount of money invested in technology is proportional and sufficient to the amount of business associated with for these assets. The large size of most of the bubbles in this group indicate that the company spends more money in this area of business than any other, so it is likely the most important. Inspecting lighter shaded bubbles 28, 30, 31, 32, and 33 indicates that these assets are of medium importance to the overall business of the company. Their positioning on graph 1700 shows that these assets generate a large amount of business value as compared to the maturity of the technology associated with them. This would indicate to a company that it needs to invest much more heavily in developing these assets to maximize their potential value. For each of these assets, the summary at asset level 1600 would likely provide a planned action of “invest”.

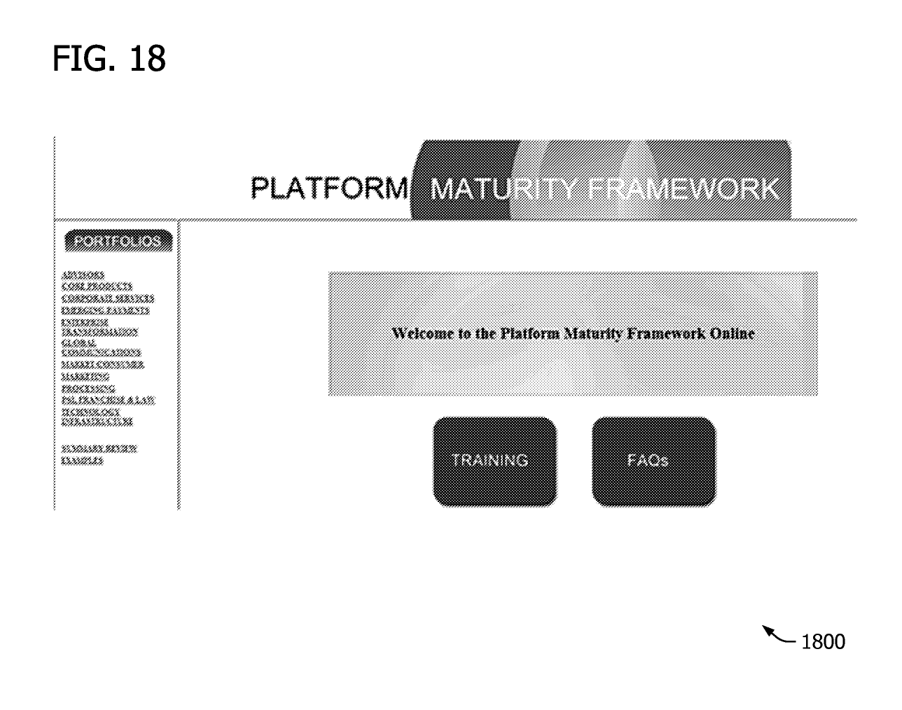

FIG. 18 is a screenshot 1800 generated by at least one of TEM computer device 121 (shown in FIGS. 1 and 2) and TME computer device 114 (shown in FIGS. 1 and 2) to allow a user such as user 201 (shown in FIG. 3) to access technological maturity data. More specifically, screenshot 1800 shows an introductory screen which may allow a user such as user 201 (shown in FIG. 3) to view data generated by TEM computer device 121 or TME computer device 114.

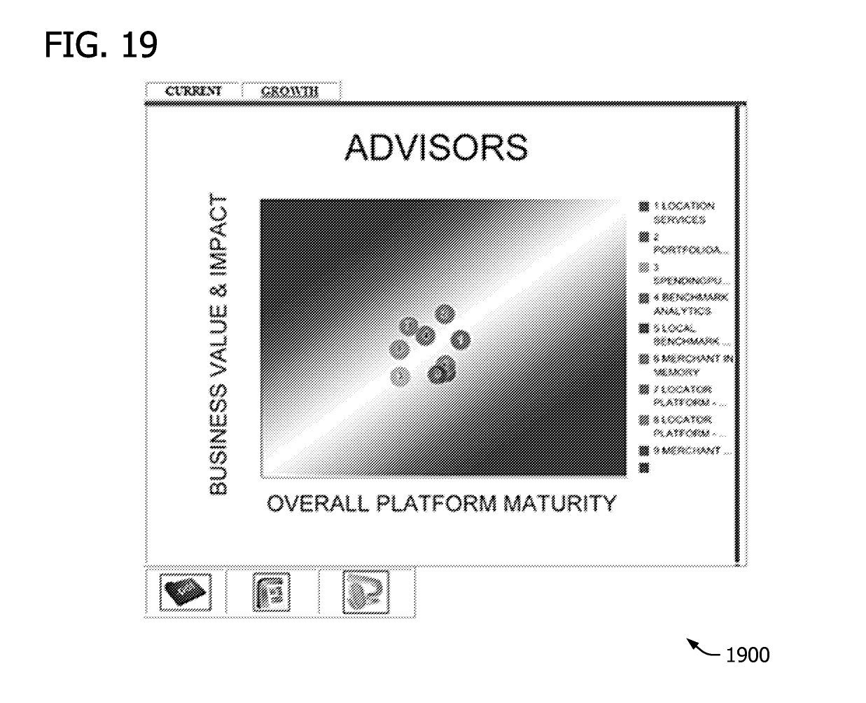

FIG. 19 is a screenshot 1900 generated by at least one of TEM computer device 121 (shown in FIGS. 1 and 2) and TME computer device 114 (shown in FIGS. 1 and 2) and illustrating the technical maturity scores for a plurality of assets. As indicated in screenshot 1900, individual assets are represented in terms of business value and impact (as charted on the y-axis) and overall platform maturity (as charted on the x-axis). Screenshot 1900 indicates the current business value and impact and overall platform maturity of ten technology assets.

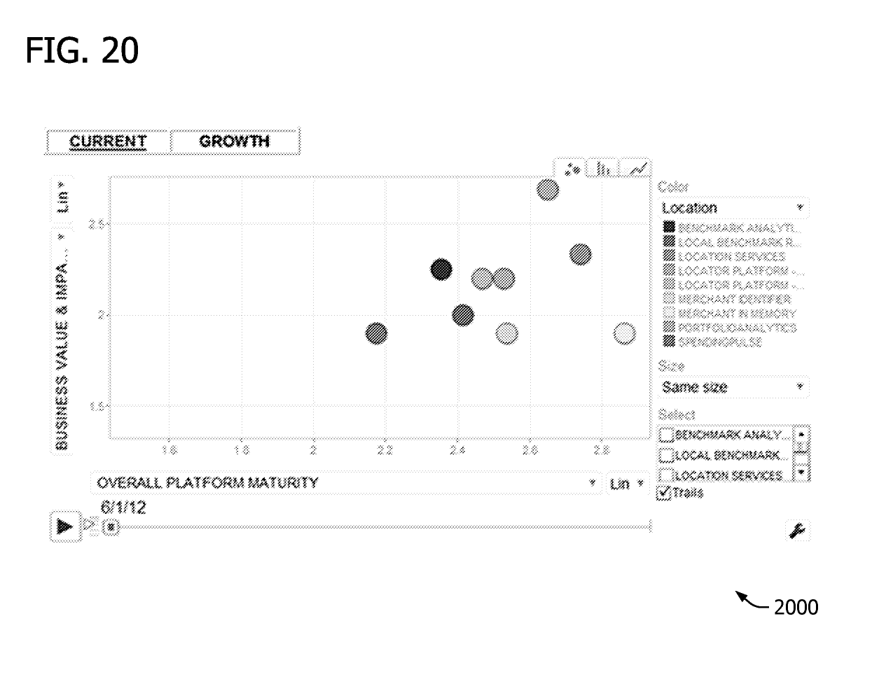

FIG. 20 is a screenshot 2000 generated by at least one of TEM computer device 121 (shown in FIGS. 1 and 2) and TME computer device 114 (shown in FIGS. 1 and 2) and illustrating growth scores for a plurality of assets. In other words, screenshot 2000 indicates the growth rates of a plurality of assets with respect to business value and impact (as charted on the y-axis) and overall platform maturity (as charted on the x-axis).

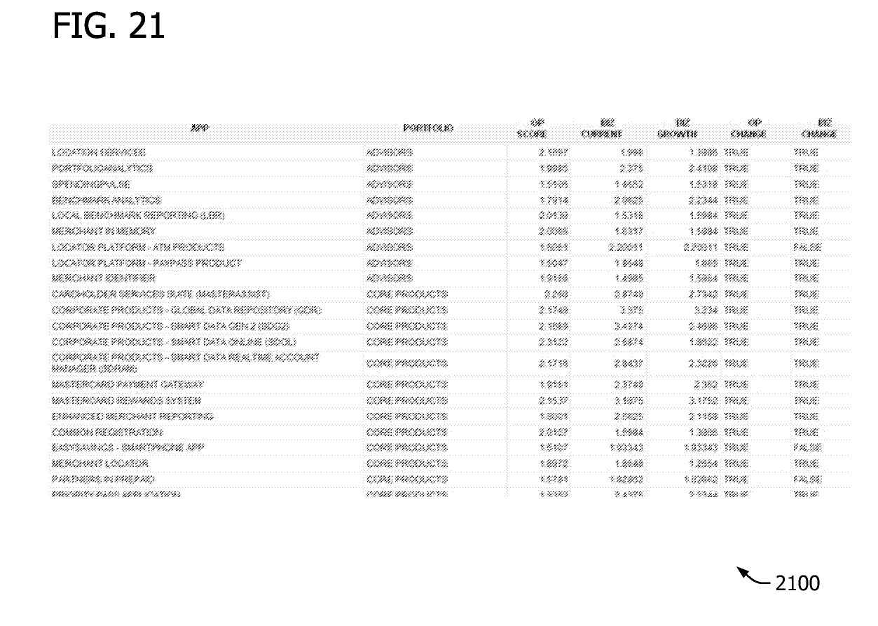

FIG. 21 is a screenshot 2100 generated by at least one of TEM computer device 121 (shown in FIGS. 1 and 2) and TME computer device 114 (shown in FIGS. 1 and 2) and illustrating a tabular view of technical and business maturity scores for a plurality of assets. More specifically, assets are listed by portfolio, operational score, current business score, growth business score, operational change, and business change.

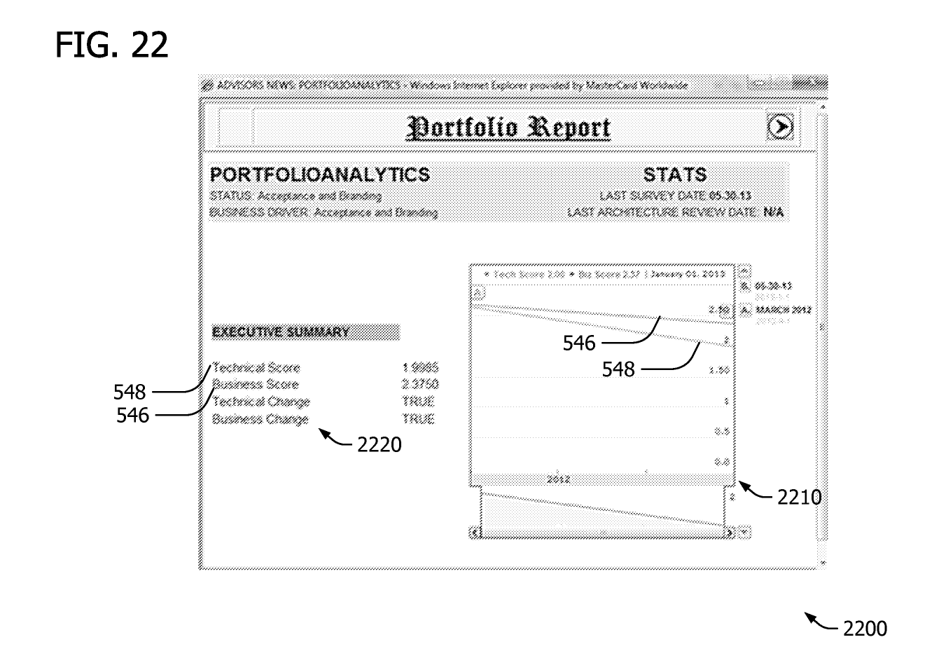

FIG. 22 is a screenshot 2200 generated by at least one of TEM computer device 121 (shown in FIGS. 1 and 2) and TME computer device 114 (shown in FIGS. 1 and 2) and illustrating a report of technical maturity scores for a particular asset over a period of time. More specifically, a chart 2210 of the technological maturity evaluation of an asset is shown from March, 2012 until May, 2013. The upper line indicates business score 546 while the lower line indicates technical score 548 over the time range displayed. Screenshot 2200 also includes a tabular executive summary 2220 of the technological maturity of the asset over the period, showing business score 546 and technical score 548 in the period.

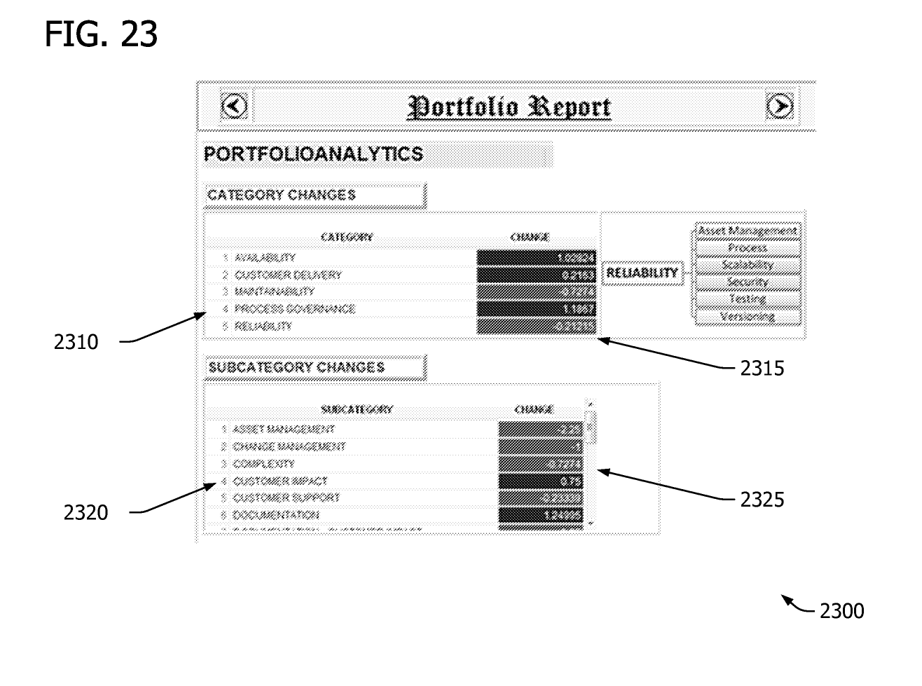

FIG. 23 is a screenshot 2300 generated by at least one of TEM computer device 121 (shown in FIGS. 1 and 2) and TME computer device 114 (shown in FIGS. 1 and 2) and illustrating a report of the breakdown of technical maturity scores for a particular asset. More specifically, screenshot 2300 indicates a breakdown based on categories 2310 and sub-categories 2320. Note that categories 2310 correspond to categories of survey questions 610 (shown in FIG. 6) used to generate surveys 722 (shown in FIG. 7). In the example, sub-categories 2320 reflect sub-categories associated with the category 2310 of reliability. Screenshot 2300 further indicates category change scores 2315 and sub-category change scores 2325.

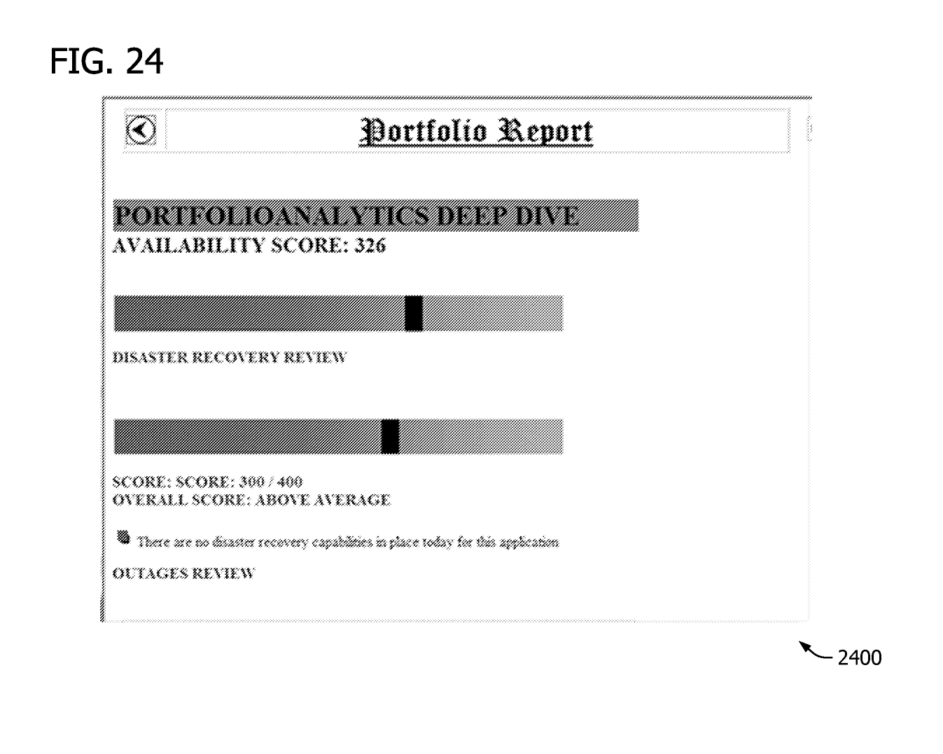

FIG. 24 is a screenshot 2400 generated by at least one of TEM computer device 121 (shown in FIGS. 1 and 2) and TME computer device 114 (shown in FIGS. 1 and 2) and illustrating a further breakdown of technical maturity scores for a particular asset. More specifically, screenshot 2400 indicates a deeper analysis of sub-category 2320 (shown in FIG. 23) for disaster recovery associated with category 2310 (shown in FIG. 23) for availability. Accordingly, screenshot 2400 displays the ability of TME computer device 114 to generate reports of business score 546 and technical score 548 (both shown in FIG. 5) at the level of sub-category 2320.

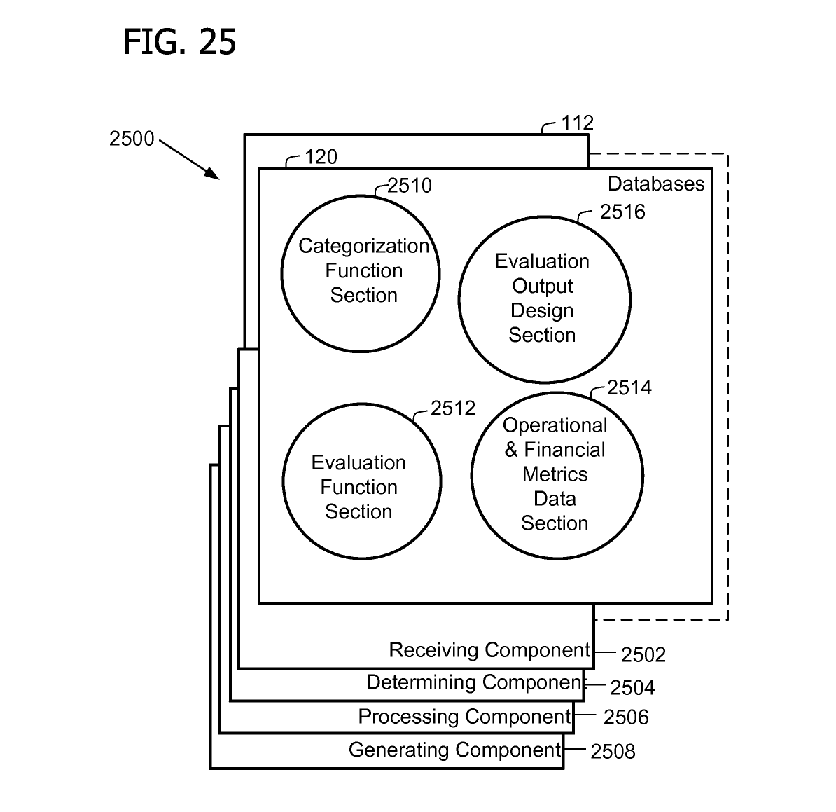

FIG. 25 is a diagram 2500 of components of one or more example computer devices, for example TEM computer device 121, which may be used in the environment shown in FIG. 5. FIG. 25 further shows a configuration of databases including at least database 120 (shown in FIG. 1). Database 120 is coupled to several separate components within TEM computer device 121, which perform specific tasks.

TEM computer device 121 includes a receiving component 2502 for receiving a first data set, wherein the first data set includes data related to receiving 1210 (shown in FIG. 12A) a first data set 510 (shown in FIG. 5) associated with a technology asset. TEM computer device 121 also includes an determining component 2504 for determining 1220 (shown in FIG. 12A) at least one evaluation function and at least one categorization function to apply to the first data set. TEM computer device 121 additionally includes a processing component 2506 for processing 1230 (shown in FIG. 12A) the first data set using the at least one evaluation function and the at least one categorization function to determine a second data set. TEM computer device 121 additionally includes a generating component 2508 for generating 1240 (shown in FIG. 12A) at least one evaluation output based upon the second data set.

In an exemplary embodiment, database 120 is divided into a plurality of sections, including but not limited to, a categorization function section 2510, an evaluation functions section 2512, an operational and financial metrics data section 2514, and an evaluation output design section 2516. These sections within database 120 are interconnected to update and retrieve the information as required.

The above-described methods and systems provide for evaluating technological assets within an organization. The methods and systems described herein facilitate evaluating assets by receiving a data set, determining an appropriate evaluation and categorization function, processing the data set with the evaluation and categorization functions, and generating an evaluation output based upon the processed data set. Moreover, the methods and systems described herein facilitate (i) receiving a first data set, wherein the first data set includes data related to the a first technology asset; (ii) determining at least one evaluation function and at least one categorization function to apply to the first data set; (iii) processing the first data set using the at least one evaluation function and the at least one categorization function to determine a second data set, wherein the second data set includes data related to a technological evaluation of the first technology asset; and (iv) generating at least one evaluation output based upon the second data set, wherein the evaluation output represents an output indicating the technological evaluation of the first technology asset.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A technology evaluation measurement (TEM) computer device for evaluating a technology asset of an entity, said TEM computer device comprising:
a processor in communication with a memory, said TEM computer device programmed to:
receive a first data set including data related to a first technology asset;
determine at least one evaluation function and at least one categorization function to apply to the first data set, wherein the at least one categorization function is configured to determine a context of the first technology asset, and wherein the at least one evaluation function is configured to determine a quantitative evaluation of the first technology asset based on the first data set and the context of the first technology asset;
process the first data set using the at least one evaluation function and the at least one categorization function to generate a second data set, wherein the second data set includes data related to a technological evaluation of the first technology asset; and
generate at least one evaluation output based upon the second data set, wherein the evaluation output represents an output indicating the technological evaluation of the first technology asset.

2. A TEM computer device in accordance with claim 1, wherein said TEM computer device is further programmed to:
receive a first data feed from at least one external data source; and
extract the first data set from the first data feed.

3. A TEM computer device in accordance with claim 1, wherein said TEM computer device is further programmed to:
receive response data from each of a plurality of subject matter experts regarding the technological evaluation of the first technology asset; and
process the response data with the first data set.

4. A TEM computer device in accordance with claim 3, wherein said TEM computer device is further programmed to:
automatically poll the plurality of subject matter experts for response data.

5. A TEM computer device in accordance with claim 1, wherein said TEM computer device is further programmed to generate an investment monitoring output representative of at least one of:
a capital investment allocated to the first technology asset; and
a human resource investment allocated to the first technology asset.

6. A TEM computer device in accordance with claim 1, wherein said TEM computer device is further programmed to generate a capacity monitoring output representing an available resource capacity related to the first technology asset wherein the capacity monitoring output is at least one of:
a quantitative measurement of available resource capacity; and
a capacity indicator status wherein the capacity indicator status is at least one of under capacity, at capacity, or over capacity.

7. A TEM computer device in accordance with claim 1, wherein said TEM computer device is further programmed to process the first data set using the at least one evaluation function wherein the at least one evaluation function is a dynamic weighting function, wherein the dynamic weighting function is configured to receive input from at least one of a user and an expert system.

8. A TEM computer device in accordance with claim 1, wherein said TEM computer device is further programmed to process the first data set using at least one categorization function wherein the at least one categorization function determines an investment category related to the first technology asset.

9. A TEM computer device in accordance with claim 1, wherein said TEM computer device is further programmed to:
calculate a business value score and a technical maturity score for the first technology asset based upon at least in part upon the second data set, wherein the business value score represents an overall value and impact the first technology asset has in a marketplace, and wherein the technical maturity score represents an amount of resources invested to develop and implement the first technology asset.

10. A computer-implemented method for evaluating a technology asset of an entity using a technology evaluation measurement (TEM) computer device, wherein the TEM computer device includes a memory and a processor, said method comprising:
receiving, by the TEM computer device, a first data set including data related to a first technology asset;
determining, by the TEM computer device, at least one evaluation function and at least one categorization function to apply to the first data set, wherein the at least one categorization function is configured to determine a context of the first technology asset, and wherein the at least one evaluation function is configured to determine a quantitative evaluation of the first technology asset based on the first data set and the context of the first technology asset;
processing the first data set using the at least one evaluation function and the at least one categorization function to generate a second data set, wherein the second data set includes data related to a technological evaluation of the first technology asset; and
generating at least one evaluation output based upon the second data set, wherein the evaluation output represents an output indicating the technological evaluation of the first technology asset.

11. A computer-implemented method in accordance with claim 10, further comprising:
receiving, by the TEM computer device, a first data feed from at least one external data source; and
extracting the first data set from the first data feed.

12. A computer-implemented method in accordance with claim 10, further comprising:
receiving response data from each of a plurality of subject matter experts regarding the technological evaluation of the first technology asset; and
processing the response data with the first data set.

13. A computer-implemented method in accordance with claim 12, further comprising:
automatically polling the plurality of subject matter experts for response data.

14. A computer-implemented method in accordance with claim 10, further comprising generating an investment monitoring output representative of at least one of:
a capital investment allocated to the first technology asset; and
a human resource investment allocated to the first technology asset.

15. A computer-implemented method in accordance with claim 10, further comprising generating a capacity monitoring output representing an available resource capacity related to the first technology asset wherein the capacity monitoring output is at least one of:
a quantitative measurement of available resource capacity; and
a capacity indicator status wherein the capacity indicator status is at least one of under capacity, at capacity, or over capacity.

16. A computer-implemented method in accordance with claim 10, further comprising processing the first data set using the at least one evaluation function wherein the at least one evaluation function is a dynamic weighting function, wherein the dynamic weighting function configured to receive input from at least one of a user and an expert system.

17. A computer-implemented method in accordance with claim 10, further comprising processing the first data set using at least one categorization function wherein the at least one categorization function determines an investment category related to the first technology asset.

18. A computer-implemented method in accordance with claim 10, further comprising:
calculating a business value score and a technical maturity score for the first technology asset based upon at least in part upon the second data set, wherein the business value score represents an overall value and impact the first technology asset has in a marketplace, and wherein the technical maturity score represents an amount of resources invested to develop and implement the first technology asset.

19. One or more non-transitory computer-readable storage media having computer-executable instructions embodied thereon for evaluating a technology asset of an entity by a technology evaluation measurement (TEM) computer device, wherein the TEM computer device includes a memory and a processor, wherein when executed by said processor, said computer-executable instructions cause said processor to:
receive a first data set including data related to a first technology asset;
determine at least one evaluation function and at least one categorization function to apply to the first data set, wherein the at least one categorization function is configured to determine a context of the first technology asset, and wherein the at least one evaluation function is configured to determine a quantitative evaluation of the first technology asset based on the first data set and the context of the first technology asset;
process the first data set using the at least one evaluation function and the at least one categorization function to generate a second data set, wherein the second data set includes data related to a technological evaluation of the first technology asset; and
generate at least one evaluation output based upon the second data set, wherein the evaluation output represents an output indicating the technological evaluation of the first technology asset.

20. The one or more non-transitory computer-readable storage media in accordance with claim 19, wherein said computer-executable instructions further cause said processor to:
receive a first data feed from at least one external data source; and
extract the first data set from the first data feed.

21. The one or more non-transitory computer-readable storage media in accordance with claim 19, wherein said computer-executable instructions further cause said processor to:
receive response data from each of a plurality of subject matter experts regarding the technological evaluation of the first technology asset; and
process the response data with the first data set.
